(19) United States
(12) Patent Application Publication
(10) Pub. No.: US 2026/0277148 A1
(43) Pub. Date: Sep. 17, 2026

(54) BOOKLET PRODUCING APPARATUS

(71) Applicant: CANON KABUSHIKI KAISHA, Tokyo (JP)

(72) Inventors: HIROHARU TSUJI, Shizuoka (JP); SEIJI OBATA, Shizuoka (JP)

(21) Appl. No.: 19/563,060

(22) Filed: Mar. 11, 2026

(30) Foreign Application Priority Data
Mar. 14, 2025 (JP) 2025-041696

(51) Int. Cl. G03G 15/00

(52) U.S. Cl. CPC G03G 15/6544; G03G 2215/00936

(57) ABSTRACT

Disclosed is a booklet producing apparatus including an application unit configured to apply adhesive onto a sheet, a stacking portion on which a plurality of sheets onto which the adhesive has been applied by the application unit are stacked, a bonding unit configured to nip and bond the plurality of sheets stacked on the stacking portion with the adhesive, and a control unit configured to execute an operation of producing a booklet, the control unit being configured to control the application unit such that an amount of the adhesive per unit area of a layer of the adhesive formed between each pair of adjacent sheets in the booklet varies depending on a position of the layer of the adhesive in a thickness direction of the booklet.

### BACKGROUND

### Field of the Technology

The present disclosure relates to a booklet producing apparatus that produces a booklet by binding a plurality of sheets.

### Description of the Related Art

Japanese Patent Laid-open No. 2014-237291 describes a paper binding apparatus that applies a toner serving as a bonding medium onto a sheet, stacks a plurality of sheets, and binds the sheets by heating and pressurizing the sheets.

### SUMMARY

The present disclosure provides a booklet producing apparatus capable of reducing consumption of adhesive while suppressing a decrease in peeling strength of a booklet.

An aspect of the present disclosure provides a booklet producing apparatus including an application unit configured to apply adhesive onto a sheet, a stacking portion on which a plurality of sheets onto which the adhesive has been applied by the application unit are stacked, a bonding unit configured to nip and bond the plurality of sheets stacked on the stacking portion with the adhesive, and a control unit configured to execute an operation of producing a booklet in which each pair of adjacent sheets are bonded to each other via the adhesive using the application unit and the bonding unit, the control unit being configured to control the application unit such that an amount of the adhesive per unit area of a layer of the adhesive formed between each pair of adjacent sheets in the booklet varies depending on a position of the layer of the adhesive in a thickness direction of the booklet.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an image forming apparatus according to a first embodiment.

FIG. 2 is a view illustrating an example of a toner image formed on a sheet in the first embodiment.

FIG. 3 is a view illustrating a buffer section of a post-processing apparatus according to the first embodiment.

FIG. 4A is an explanatory view illustrating an operation of the buffer section according to the first embodiment.

FIG. 4B is an explanatory view illustrating an operation of the buffer section according to the first embodiment.

FIG. 4C is an explanatory view illustrating an operation of the buffer section according to the first embodiment.

FIG. 4D is an explanatory view illustrating an operation of the buffer section according to the first embodiment.

FIG. 4E is an explanatory view illustrating an operation of the buffer section according to the first embodiment.

FIG. 4F is an explanatory view illustrating an operation of the buffer section according to the first embodiment.

FIG. 4G is an explanatory view illustrating an operation of the buffer section according to the first embodiment.

FIG. 4H is an explanatory view illustrating an operation of the buffer section according to the first embodiment.

FIG. 5 is a view illustrating an alignment section of the post-processing apparatus according to the first embodiment.

FIG. 6 is an exploded view of a movable unit of the alignment section according to the first embodiment.

FIG. 7A is an explanatory view illustrating an operation of the alignment section according to the first embodiment.

FIG. 7B is an explanatory view illustrating an operation of the alignment section according to the first embodiment.

FIG. 7C is an explanatory view illustrating an operation of the alignment section according to the first embodiment.

FIG. 7D is an explanatory view illustrating an operation of the alignment section according to the first embodiment.

FIG. 8 is a perspective view of a heat-pressure bonding section according to the first embodiment.

FIG. 9A is an explanatory view illustrating an operation of the heat-pressure bonding section according to the first embodiment.

FIG. 9B is an explanatory view illustrating an operation of the heat-pressure bonding section according to the first embodiment.

FIG. 9C is an explanatory view illustrating an operation of the heat-pressure bonding section according to the first embodiment.

FIG. 9D is an explanatory view illustrating an operation of the heat-pressure bonding section according to the first embodiment.

FIG. 9E is an explanatory view illustrating an operation of the heat-pressure bonding section according to the first embodiment.

FIG. 9F is an explanatory view illustrating an operation of the heat-pressure bonding section according to the first embodiment.

FIG. 10A is a view illustrating a method of measuring a bonding strength.

FIG. 10B is a view illustrating a method of measuring a booklet strength.

FIG. 10C is a view illustrating a method of measuring a booklet strength.

FIG. 11 is a graph illustrating a relationship between an amount of bonding toner relative to a position in a booklet and a booklet strength in a comparative example.

FIG. 12A is a cross-sectional view illustrating a state in the middle of peeling apart a booklet according to the first embodiment.

FIG. 12B is a cross-sectional view illustrating a state in the middle of peeling apart a booklet according to the first embodiment.

FIG. 13A is an explanatory view for explaining an amount of bonding toner according to the first embodiment.

FIG. 13B is an explanatory view for explaining an amount of bonding toner according to the first embodiment.

FIG. 14 is a graph illustrating a relationship between an amount of bonding toner relative to a position in a booklet and a booklet strength in the first embodiment.

FIG. 15 is a view illustrating an example of a toner image formed on a sheet in a modification.

FIG. 16 is an explanatory view for explaining an amount of bonding toner according to a second embodiment.

FIG. 17A is a view illustrating a pattern constituting a bonding toner image in a third embodiment.

FIG. 17B is a view illustrating a pattern constituting a bonding toner image in the third embodiment.

FIG. 17C is a view illustrating a pattern constituting a bonding toner image in the third embodiment.

FIG. 17D is a view illustrating a pattern constituting a bonding toner image in the third embodiment.

### DESCRIPTION OF THE EMBODIMENTS

Hereinafter, embodiments according to the present disclosure will be described with reference to the drawings.

In the present disclosure, an “image forming apparatus” broadly includes an apparatus that forms (records) an image on a recording material (recording medium), such as a single-function printer, a copier, a multifunction peripheral, or a commercial printer. Furthermore, the “image forming apparatus” may be a system (image forming system) in which an image forming apparatus body that forms an image on a recording material is coupled to equipment such as a post-processing apparatus and a sheet feeding apparatus.

### First Embodiment

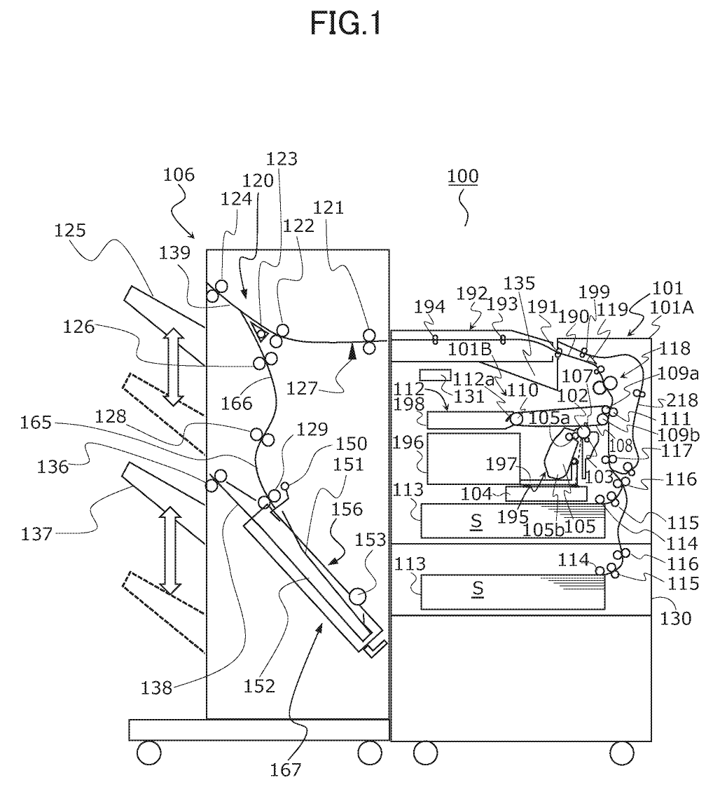

A configuration of an image forming apparatus 100 according to the first embodiment will be described with reference to FIGS. 1-9F. Regarding the order of description, an overall configuration of the image forming apparatus 100 will be described first, and then a configuration of a post-processing apparatus 106 will be described.

FIG. 1 is a schematic view of the image forming apparatus 100 according to the first embodiment. The image forming apparatus 100 includes a printer body 101 serving as an image forming apparatus body having an image forming function (printing function), and a post-processing apparatus 106 having a sheet bonding function. That is, the image forming apparatus 100 can be referred to as an image forming system including the printer body 101, which functions as an image forming apparatus by itself, and the post-processing apparatus 106.

The image forming apparatus 100 according to the present embodiment is capable of producing a booklet by applying adhesive to sheets S one by one using the printer body 101, and heat-pressure-bonding the plurality of sheets S in the post-processing apparatus 106, thereby performing printing and bookbinding with a single apparatus. That is, the image forming apparatus 100 functions as a booklet producing apparatus that produces a booklet by binding a plurality of sheets S.

As the sheets S, various sheet materials that are different in size and texture, such as paper such as plain paper or thick paper, a sheet material subjected to surface treatment such as coated paper, and a sheet material having a special shape such as a plastic film, cloth, an envelope, or index paper, can be used. The image forming apparatus 100 can also be used as an apparatus having only a function of producing a booklet without using a function of recording an image on the sheet S (printing function).

### Printer Body

The printer body 101 is an electrophotographic apparatus including a casing 101A and an electrophotographic image forming section 101B accommodated inside the casing 101A. The image forming section 101B includes an intermediate transfer belt 108 serving as an intermediate transfer member and a process cartridge 195 disposed along the intermediate transfer belt 108. The image forming section 101B is an intermediate transfer type electrophotographic unit. The process cartridge 195 includes a photosensitive drum 102 serving as an image bearing member, a charging device 103 serving as a charging unit, and a developing unit 105 serving as a developing device. The image forming section 101B includes a scanner unit 104 serving as an exposure unit and a primary transfer roller 107.

The developing unit 105 includes a developing roller 105a serving as a developer bearing member and a toner container 105b (developing container) that contains a toner serving as a developer. The developing roller 105a is rotatably held by the toner container 105b.

The process cartridge 195 is detachable from the casing 101A. A toner cartridge 196 containing a toner to be supplied to the developing unit 105 is detachably attached to the printer body 101. The “casing 101A” of the printer body 101 refers to a portion of the printer body 101 excluding the process cartridge 195 and the toner cartridge 196. The casing 101A includes a frame member such as a metal frame constituting a frame body of the printer body 101 and a member fixed to the frame body, and forms a mounting space in which the process cartridge 195 and the toner cartridge 196 are mounted.

The process cartridge 195 forms a recording toner image (print image) for recording an image on the sheet S using a toner, and forms a bonding toner image (a layer of adhesive) for bonding the sheets S to each other. The recording toner image is, for example, a text, a figure, or a photograph. The printer body 101 according to the present embodiment is a monochrome printer that records a monochrome image.

The printer body 101 uses a black toner not only for recording an image but also as an adhesive (a bonding toner or a powder bonding agent). That is, the adhesive in the present embodiment is a color toner. Using the color toner, the image forming section 101B (application unit) forms, on a sheet, a first toner image (recording toner image) for recording an image and a second toner image (bonding toner image) for bonding sheets to each other. The adhesive may not be a black toner, and may be, for example, a yellow toner. The image forming apparatus 100 may include a toner cartridge containing a bonding-dedicated toner separately from the toner used for recording an image.

The toner cartridge 196 and the process cartridge 195 attached to the casing 101A are connected via a toner conveying pipe 197. The toner cartridge 196 can supply a toner to the developing unit 105 via the toner conveying pipe 197.

Below the scanner unit 104, a cassette 113 (also referred to as a sheet tray) serving as a storage portion that stores sheets S to be used for forming images is attached to the casing 101A in a drawable manner. Further, one or more optional sheet feeding apparatuses 130 including an additional cassette 113 may be coupled to and below the casing 101A.

The intermediate transfer belt 108 is a rotatable endless belt stretched around a driving roller 109a, a stretching roller 109b, and a tension roller 110 that rotate about axes parallel to each other. The intermediate transfer belt 108 rotates counterclockwise in the drawing by rotating the driving roller 109a. On the inner peripheral side of the intermediate transfer belt 108, a primary transfer roller 107 serving as a primary transfer member is disposed at a position facing the photosensitive drum 102 via the intermediate transfer belt 108.

On the outer peripheral side of the intermediate transfer belt 108, a secondary transfer roller 111 serving as a transfer member (secondary transfer member) is disposed at a position facing the driving roller 109a via the intermediate transfer belt 108. As a nip portion between the intermediate transfer belt 108 and the secondary transfer roller 111, a transfer portion (secondary transfer portion) where a toner image is transferred to the sheet S is formed. The intermediate transfer belt 108, the primary transfer roller 107, and the secondary transfer roller 111 constitute a transfer unit for transferring a toner image formed on the photosensitive drum 102, which is an image bearing member, onto the sheet S.

A belt cleaner 112 serving as a cleaning unit that cleans the intermediate transfer belt 108 is provided at a position facing the tension roller 110 via the intermediate transfer belt 108. The belt cleaner 112 includes a cleaning member 112a such as a blade or a brush disposed in contact with the intermediate transfer belt 108, and a waste toner container 198 serving as a collection container. The belt cleaner 112 removes adhering matters such as transferred residual toner from the intermediate transfer belt 108 using the cleaning member 112a, and collects the removed adhering matters in the waste toner container 198.

A fixing device 118 serving as a fixing unit is disposed above the secondary transfer portion in the casing 101A. The fixing device 118 has a heat-fixing configuration in which a toner image is fixed by applying heat. The fixing device 118 includes a pair of rotary members (e.g., a pair of rollers including a fixing roller and a pressurizing roller) that nips and conveys the sheet S, and a heat source (e.g., a halogen lamp or an induction heating mechanism) that heats the toner image on the sheet S via the fixing roller.

Furthermore, a control section 131 serving as a control unit or a controller that integrally controls the operations of the printer body 101 and the post-processing apparatus 106 is provided in the printer body 101. The control section 131 functions as a control unit that controls the booklet producing apparatus.

Specifically, the control section 131 can execute an operation (booklet production job) of producing a booklet in which each pair of adjacent sheets among a stack of sheets are bonded to each other via a layer of adhesive using the image forming section 101B (application unit) and a heat-pressure bonding section 167 (bonding unit). The booklet production job is a series of tasks for producing a booklet by forming bonding toner images on a designated number of sheets S using the image forming section 101B, placing and aligning the designated number of sheets S using an alignment section 156, and heat-pressure-bonding the designated number of sheets S using the heat-pressure bonding section 167. The designated number of sheets is the number of sheets constituting one booklet, and is designated by a user when the booklet production job is input.

The control section 131 includes a central processing unit (CPU) and a memory. The CPU controls an operation of each section of the apparatus by reading and executing a program stored in the memory. The memory includes a nonvolatile storage medium such as a read-only memory (ROM) and a volatile storage medium such as a random access memory (RAM), and serves as an area where a program and data are stored and provides a work space when the CPU executes the program.

Note that each function of the control section 131 to be described below may be implemented on a circuit of a control section as independent hardware such as an ASIC, or may be implemented in software as a functional unit of a program executed by the CPU or another processing device. A control section (sub control section) that controls the operation of the post-processing apparatus 106 based on an instruction from the control section 131 may be mounted on the post-processing apparatus 106. In this case, the control section 131 of the printer body 101 and the control section of the post-processing apparatus 106 function as a control unit of the booklet producing apparatus.

### Image Forming Operation

An image forming operation of the printer body 101 will be described. The image forming operation is a series of operations in which the printer body 101 forms an image on the sheet S while conveying the sheet S. The printer body 101 starts an image forming operation when the control section 131 of the image forming apparatus 100 receives an image forming job, for example, from an external computer. The image forming job is a series of tasks of executing an image forming operation on sheets S as many as the number of sheets and the number of copies designated by the user based on image information (image data) and image forming conditions, and performing processing such as bonding processing based on designations from the user. The image forming conditions are, for example, a designation of single-sided printing or double-sided printing, a designation of a size of the sheet S on which an image is to be formed, a designation of whether to perform bonding processing, and a designation of a bonding position on the sheet, and the like.

In the image forming operation, the sheets S are fed by a feed roller 114 serving as a feeding unit from the cassette 113 disposed in the lower portion of the casing 101A or the cassette 113 of the sheet feeding apparatus 130. A separation roller pair 115 conveys the fed sheets S while separating the sheets S one by one. The sheet S is conveyed toward a registration roller pair 117 by a pull-out roller 116. Then, when the leading edge of the sheet S abuts against the nip portion of the registration roller pair 117 in a stopped state, the skew feeding of the sheet S is corrected. The registration roller pair 117 conveys the sheet S to the secondary transfer portion at a timing synchronized with the formation of the toner image in the image forming section 101B.

On the other hand, in the image forming section 101B, the photosensitive drum 102 and the intermediate transfer belt 108 are rotationally driven. The charging device 103 uniformly charges the surface of the photosensitive drum 102. The scanner unit 104 is driven by a time-series signal (video signal) generated by the control section 131 based on the image information, and irradiates the photosensitive drum 102 with laser light. As a result, the photosensitive drum 102 is exposed, and an electrostatic latent image is written on the surface of the photosensitive drum 102. The electrostatic latent image is developed (visualized) as a black toner image by the developing unit 105 using a black toner.

Here, in a case where the user designates the post-processing apparatus 106 to perform heat-pressure bonding (bonding processing), which will be described below, the control section 131 causes the image forming section 101B to form a bonding toner image on the sheet S in parallel with forming a recording toner image (print image) based on the image information. That is, the image forming section 101B according to the present embodiment functions as an application unit that applies a toner serving as an adhesive onto the sheet S. In the image forming section 101B, the scanner unit 104 writes an electrostatic latent image in a range on the photosensitive drum 1 corresponding to a preset bonding region (a predetermined region or an intended bonding region) on the sheet S based on an instruction from the control section 131. The electrostatic latent image is developed by the developing unit 105 using a black toner, thereby forming a bonding toner image on the photosensitive drum 102.

As will be described below, the amount of bonding toner applied onto the sheet S by the image forming section 101B may vary depending on the position of the bonding layer in the thickness direction of the booklet, which is a final product. That is, the control section 131 controls the image forming section 101B (application unit) so that the amount of adhesive per unit area in the layer of adhesive formed between a pair of adjacent sheets in the produced booklet varies depending on the position in the thickness direction of the booklet.

The toner images (the recording toner image and the bonding toner image) formed on the photosensitive drum 102 (on the image bearing member) are transferred (primarily transferred) to the intermediate transfer belt 108 by the primary transfer roller 107, and are conveyed toward the secondary transfer portion as the intermediate transfer belt 108 rotates. Then, in the secondary transfer portion, the toner image is transferred (secondarily transferred) to the sheet S sent from the registration roller pair 117 by applying a voltage to the secondary transfer roller 111. The sheet S having passed through the secondary transfer portion is sent to the fixing device 118, and the toner image is heated and pressurized while passing through the nip portion between the fixing roller and the pressurizing roller, whereby the toner is softened and then solidified, so that the toner image is fixed onto the sheet S. The conveyance path of the sheet S having passed through the fixing device 118 is switched by a switching member 119.

In the case of single-sided printing, the sheet S is guided to a discharge path 190 by the switching member 119, and is discharged from the casing 101A by a sheet discharge roller pair 191. In the present embodiment, the printer body 101 is coupled to the post-processing apparatus 106 via a relay conveyance unit 192. The sheet S discharged from the sheet discharge roller pair 191 is delivered to the post-processing apparatus 106 via conveyance roller pairs 193 and 194 of the relay conveyance unit 192. In a case where the relay conveyance unit 192 and the post-processing apparatus 106 are not coupled, the sheet discharge roller pair 191 can discharge the sheet S as a final product to a support tray 135 provided in the upper portion of the casing 101A.

In the case of double-sided printing, the sheet S having the toner image formed on its first surface is guided to a reverse conveyance roller pair 199 by the switching member 119. Then, the sheet S is reversely conveyed (conveyed switchback) by the reverse conveyance roller pair 199, and then conveyed toward the registration roller pair 117 via a duplex conveyance path 218. The sheet S passes through the secondary transfer portion and the fixing device 118, whereby a toner image is formed on the second surface on the back side of the first surface, and thereafter the sheet S is discharged from the casing 101A by the sheet discharge roller pair 191.

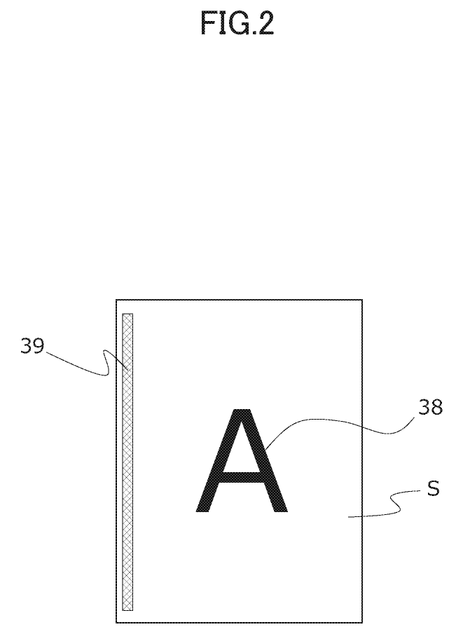

FIG. 2 is a view illustrating an example of a toner image formed on the sheet S. On the illustrated sheet S, a recording toner image 38 for recording an image such as a text, a figure, or a photograph, and a bonding toner image 39 for bonding sheets to each other are formed.

In the first embodiment, the bonding toner image 39 is formed in a band-like bonding region along one long side of the sheet S. The bonding toner image 39 enables processing (long side binding) of binding sheets to each other at edge portions along the long side. However, the position, shape, size, and the like of the bonding toner image 39 can be changed according to the configuration of the heat-pressure bonding section 167, which will be described below.

In a case where the image forming apparatus 100 produces a single-sided printing booklet, the bonding toner image 39 may be formed on only one side of the sheet S (on the same side as the recording toner image). In a double-sided printing booklet, the bonding toner image 39 may be formed on only one side of the sheet S or may be formed on both sides of the sheet S. Hereinafter, the toner constituting the bonding toner image 39 may be referred to as “bonding toner”. The bonding toner according to the present embodiment is the same as the toner constituting the recording toner image.

### Post-Processing Apparatus

The post-processing apparatus 106 includes a buffer section 120 (stacking processing section) serving as a buffer unit that stacks a plurality of sheets S on one another, an alignment section 156 serving as a loading/aligning unit that loads and aligns the plurality of sheets S, and a heat-pressure bonding section 167 that heat-pressure-bonds the sheets S to each other. The heat-pressure bonding section 167 is an example of a bonding unit that bonds sheets to each other. The heat-pressure bonding section 167 nips the plurality of sheets S stacked on a lower intermediate guide 152 (stacking portion) and bonds the sheets S using a toner serving as an adhesive. The heat-pressure bonding section 167 can also be referred to as a bonding unit, a heat-pressure bonding unit, or a bonding processing section. In addition, the post-processing apparatus 106 includes an upper sheet discharge tray 125 and a lower sheet discharge tray 137 that can be moved up and down as discharge destinations for discharging final products of the image forming apparatus 100.

The post-processing apparatus 106 is an apparatus (a binding apparatus or a booklet forming apparatus) that sequentially receives a plurality of sheets S on which images are formed one by one by the printer body 101, stacks the sheets S, and performs bonding processing (heat-pressure bonding), thereby discharging the sheets S as a bundle of sheets bound (booklet). The buffer section 120, the alignment section 156, and the heat-pressure bonding section 167 will be described in detail below. Further, the post-processing apparatus 106 can discharge the sheets S on which images have been formed by the printer body 101 to the upper sheet discharge tray 125 or the lower sheet discharge tray 137 without performing processing. The post-processing apparatus 106 includes a sheet discharge conveyance path 138 extending from the heat-pressure bonding section 167 toward the lower sheet discharge tray 137.

### Configuration of Buffer Section

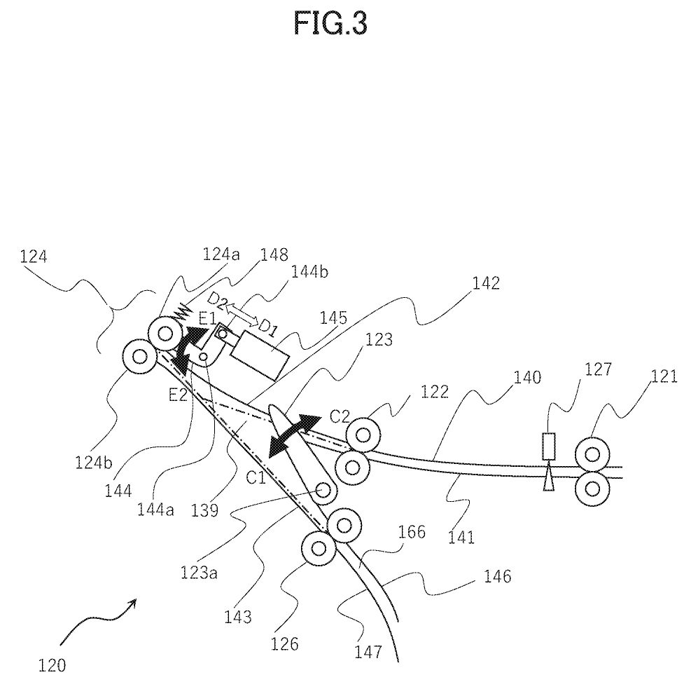

The configuration of the buffer section 120 will be described with reference to FIG. 3. FIG. 3 is an enlarged cross-sectional view of the buffer section 120. The buffer section 120 includes an inlet roller pair 121, a pre-buffer roller pair 122, a backflow prevention valve 123, a reverse conveyance roller pair 124, and an inner sheet discharge roller pair 126. In addition, the buffer section 120 includes an inlet sensor 127 that detects a sheet and a separation mechanism for opening and closing (bringing into contact and separating) the reverse conveyance roller pair 124. The separation mechanism includes a plunger solenoid 145.

Each of the inlet roller pair 121, the pre-buffer roller pair 122, the reverse conveyance roller pair 124, and the inner sheet discharge roller pair 126 is a pair of rollers that nip and convey a sheet. The inlet roller pair 121 and the pre-buffer roller pair 122 are disposed on a conveyance path (inlet path) for the post-processing apparatus 106 to receive the sheet S. The reverse conveyance roller pair 124 is disposed on a conveyance path 139 communicating with the upper sheet discharge tray 125. The inner sheet discharge roller pair 126 is disposed on an inner sheet discharge path 166 extending from the reverse conveyance roller pair 124 toward the heat-pressure bonding section 167.

The inlet path is formed by an upper inlet guide 140 and a lower inlet guide 141. The first sheet discharge path is formed by an upper reverse conveyance guide 142 and a lower reverse conveyance guide 143. The inner sheet discharge path 166 is formed by an upper inner sheet discharge guide 146 and a lower inner sheet discharge guide 147.

The inlet sensor 127 is disposed to detect the sheet received by the inlet roller pair 121. As the inlet sensor 127, for example, a reflective photosensor that determines whether there is a sheet S by irradiating the inlet path with infrared light through an opening provided in the upper inlet guide 140 and detecting reflected light from a sheet can be used. The lower inlet guide 141 may have a hole having a diameter equal to or larger than the spot diameter of the infrared light emitted by the inlet sensor 127 so as not to reflect the infrared light when the sheet does not pass through the inlet path.

The backflow prevention valve 123 is disposed downstream of the pre-buffer roller pair 122 in the sheet conveyance direction of the inlet path. The backflow prevention valve 123 is provided to be pivotable about a pivot fulcrum 123a with respect to the upper inner sheet discharge guide 146. The backflow prevention valve 123 is pivotable between a first position for preventing the sheet from backflow from the first sheet discharge path to the inlet path and a second position for allowing the sheet to be conveyed from the inlet path to the first sheet discharge path. The backflow prevention valve 123 is biased in a C2 direction from the second position toward the first position by a spring (not illustrated). The backflow prevention valve 123 is configured to move in a C1 direction from the first position to the second position when pressed by a leading edge of a sheet conveyed downstream in the inlet conveyance path, and return to the first position after the sheet passes.

A leading edge portion of the backflow prevention valve 123 located at the first position is in an overlapping positional relationship with the upper reverse conveyance guide 142. In addition, the leading edge portion of the backflow prevention valve 123 is configured in a comb-like shape so as to allow an overlap with the upper reverse conveyance guide 142. In addition, a space through which a sheet can pass is formed between the backflow prevention valve 123 located at the second position and the upper reverse conveyance guide 142.

The reverse conveyance roller pair 124 includes an upper reverse conveyance roller 124a and a lower reverse conveyance roller 124b, and a rotational driving force is supplied to both rollers. The upper reverse conveyance roller 124a and the lower reverse conveyance roller 124b are configured to rotate in synchronization at all times. A separating lever 144 is connected to the upper reverse conveyance roller 124a. The separating lever 144 is supported so as to be pivotable about a lever fulcrum shaft 144a with respect to the upper reverse conveyance guide 142. The separating lever 144 is connected to the plunger solenoid 145 so as to be pivotable about a solenoid connection shaft 144b.

When the plunger solenoid 145 is energized, the plunger moves in a D1 direction in the drawing, so that the separating lever 144 pivots in an E1 direction in the drawing. In this case, the reverse conveyance roller pair 124 is in a separated state where the upper reverse conveyance roller 124a and the lower reverse conveyance roller 124b are separated from each other (a state where the nip portion is opened). When the energization of the plunger solenoid 145 is stopped, the upper reverse conveyance roller 124a moves in an E2 direction and the plunger of the plunger solenoid 145 moves in a D2 direction due to a biasing force of a pressurizing spring 148. In this case, the reverse conveyance roller pair 124 is in a contact state where the upper reverse conveyance roller 124a and the lower reverse conveyance roller 124b are in contact with each other (a state where the nip portion is formed).

### Buffer Operation

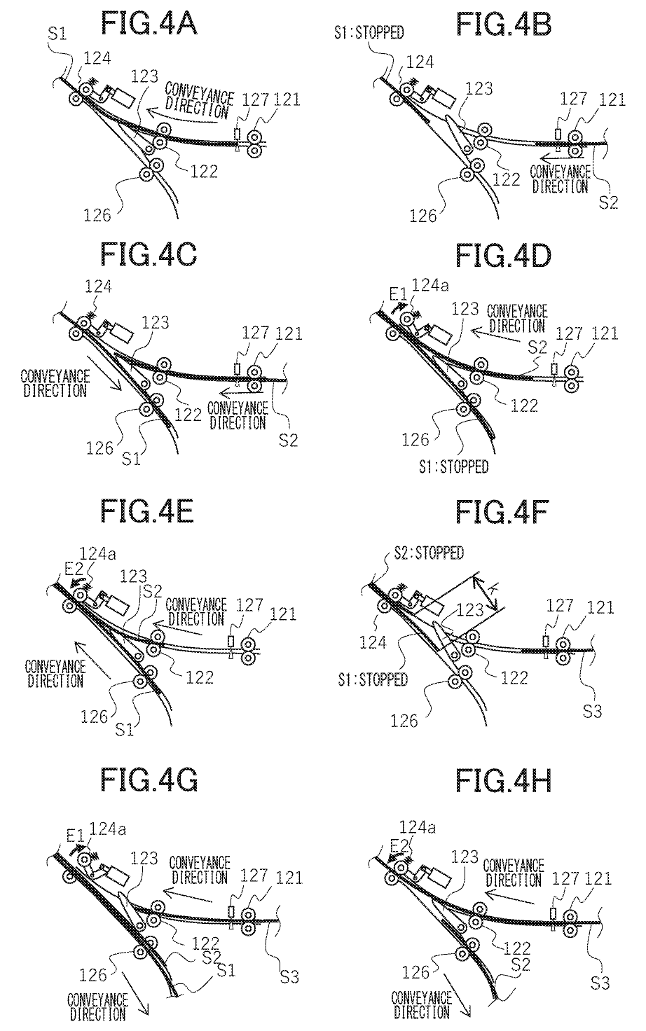

Next, an operation of the buffer section 120 will be described. FIGS. 4A-4H are views illustrating the operation of the buffer section 120. Hereinafter, it is assumed that sheets are conveyed from the printer body 101 to the post-processing apparatus 106 in the order of sheet S1, sheet S2, and sheet S3.

As will be described below, the buffer section 120 performs an operation of stacking a newly conveyed sheet on the sheet (bundle) while moving the sheet or the bundle of sheets back and forth between the reverse conveyance roller pair 124 and the inner sheet discharge roller pair 126 (hereinafter, referred to as a buffer operation). The post-processing apparatus 106 accelerates or decelerates the sheet conveyance speed in the apparatus. Hereinafter, a speed at which a sheet is conveyed by the inlet roller pair 121 is defined as V1, and a speed at which the sheet is conveyed by the pre-buffer roller pair 122, the reverse conveyance roller pair 124, and the inner sheet discharge roller pair 126 (conveyance speed after acceleration) is defined as V2.

As illustrated in FIG. 4A, when the trailing edge of the preceding sheet S1 passes through the inlet sensor 127, the speed at which the sheet S1 is conveyed by the pre-buffer roller pair 122 and the reverse conveyance roller pair 124 is accelerated from V1 to V2. As a result, the conveyance interval between the sheet S1 and the succeeding sheet S2 increases, enabling the reverse conveyance roller pair 124 to perform an operation of switching-back the sheet S1 without the sheet S2 colliding with the sheet S1.

As illustrated in FIG. 4B, when the trailing edge of the sheet S1 passes through the backflow prevention valve 123, the conveyance of the sheet S1 by the reverse conveyance roller pair 124 is temporarily stopped. As illustrated in FIG. 4C, the reverse conveyance roller pair 124 changes its rotation direction and conveys the sheet S1 toward the inner sheet discharge roller pair 126.

As illustrated in FIG. 4D, at a position where the leading edge of the sheet S1 passes through the inner sheet discharge roller pair 126 and is conveyed by a predetermined amount, the conveyance of the sheet S1 by the reverse conveyance roller pair 124 and the inner sheet discharge roller pair 126 is stopped. In addition, the upper reverse conveyance roller 124a moves in the E1 direction after the sheet S1 is nipped by the inner sheet discharge roller pair 126. As a result, the reverse conveyance roller pair 124 is in the separated state, making it possible to receive the succeeding sheet S2. After the upper reverse conveyance roller 124a is separated, the succeeding sheet S2 is conveyed to the reverse conveyance roller pair 124.

As illustrated in FIG. 4E, when the trailing edge of the succeeding sheet S2 passes through the inlet sensor 127, the speed at which the sheet S2 is conveyed is accelerated from V1 to V2, similarly to the sheet S1. At a timing when the sheet S2 reaches a predetermined target position, the inner sheet discharge roller pair 126 conveys the sheet S1 toward the reverse conveyance roller pair 124. At a timing when the speeds of the sheet S1 and the sheet S2 become substantially equal (the speed difference becomes substantially 0), the upper reverse conveyance roller 124a moves in the E2 direction, and the reverse conveyance roller pair 124 comes into contact. Upon contact, the reverse conveyance roller pair 124 nips the sheets S1 and S2 simultaneously. The speed of the reverse conveyance roller pair 124 is adjusted so as to be equal to the speed at which the sheets S1 and S2 are conveyed until switching from the separated state to the contact state.

As illustrated in FIG. 4F, after the trailing edge of the sheet S2 passes through the backflow prevention valve 123, the reverse conveyance roller pair 124 is temporarily stopped again. Here, the above-described target position is set such that the sheet S1 protrudes by a predetermined amount k relative to the sheet S2 in the conveyance direction from the inner sheet discharge roller pair 126 toward the alignment section 156. In other words, among the bundle of sheets stacked in the buffer section 120, the sheet S1 located lower in the alignment section 156 protrudes by the predetermined amount k downstream in the conveyance direction toward the alignment section 156 relative to the sheet S2 located upper in the alignment section 156.

As illustrated in FIG. 4G, the reverse conveyance roller pair 124 changes its rotation direction and conveys the sheets S1 and S2 toward the inner sheet discharge roller pair 126. The sheets S1 and S2 are conveyed toward the alignment section 156 by the inner sheet discharge roller pair 126. The upper reverse conveyance roller 124a moves in the E1 direction after the sheet S1 is nipped by the inner sheet discharge roller pair 126. As a result, the reverse conveyance roller pair 124 is in the separated state, making it possible to receive the succeeding sheet S3.

As illustrated in FIG. 4H, after the trailing edge of the sheet S2 passes through the reverse conveyance roller pair 124, the upper reverse conveyance roller 124a moves in the E2 direction. As a result, the reverse conveyance roller pair 124 comes into contact, and nips and conveys the sheet S3.

By repeatedly performing the buffer operation described above, the buffer section 120 can send the sheets to the alignment section 156 in a state where a predetermined number of sheets are stacked. In addition, although the buffer operation of stacking two sheets has been described here as an example, the sheet S3 can be further stacked on the sheets S1 and S2 by temporarily stopping the conveyance of the sheets S1 and S2 from the state of FIG. 4G and then conveying the sheets S1 and S2 in the opposite direction. That is, the buffer section 120 can produce a sheet bundle in which three or more sheets are stacked by repeating the operations of FIGS. 4D-4G.

The target position for stacking the sheets on one another is determined based on the timing when the inlet sensor 127 detects the trailing edge of the sheet. Therefore, even if the length of the sheet S in the sheet conveyance direction changes, the sheets can be stacked while being shifted from one another by a predetermined amount by the buffer operation according to the present embodiment.

As illustrated in FIG. 1, the bundle of sheets stacked in the buffer section 120 is conveyed from the inner sheet discharge roller pair 126 to a kick-out roller pair 129 via an intermediate conveyance roller pair 128 along a carry-in conveyance path 165. Then, the sheet bundle is conveyed by the kick-out roller pair 129 to the alignment section 156 including an upper intermediate guide 151, a lower intermediate guide 152, etc. A bundle pressing flag 150 is disposed downstream of the kick-out roller pair 129 to suppress the trailing edges of the stacked sheets from floating up, so that the trailing edges of the sheets already placed on the alignment section 156 do not interfere with a leading edge of a succeeding sheet conveyed to the alignment section 156.

### Alignment Section

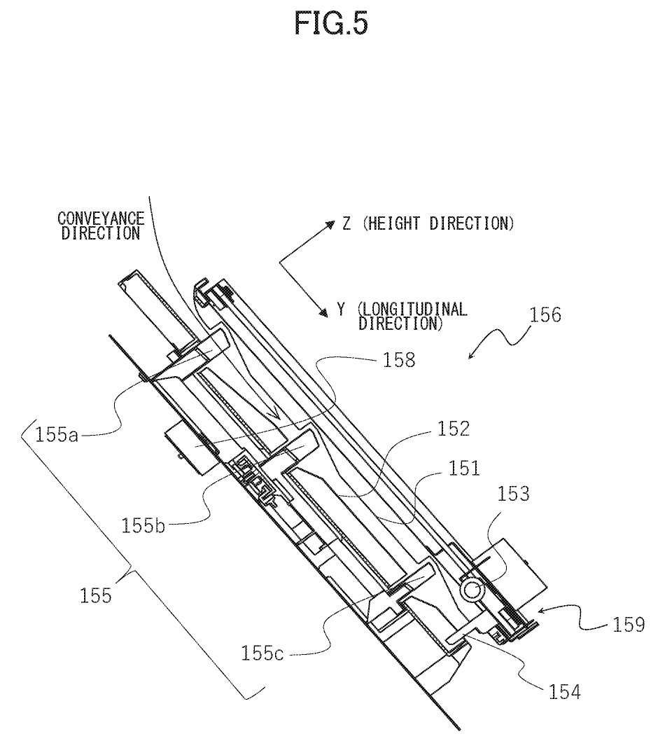

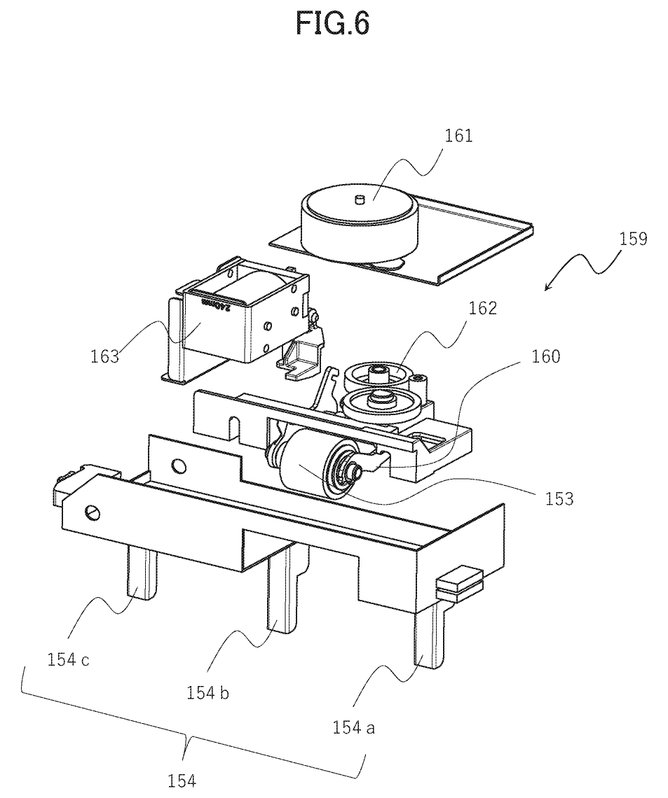

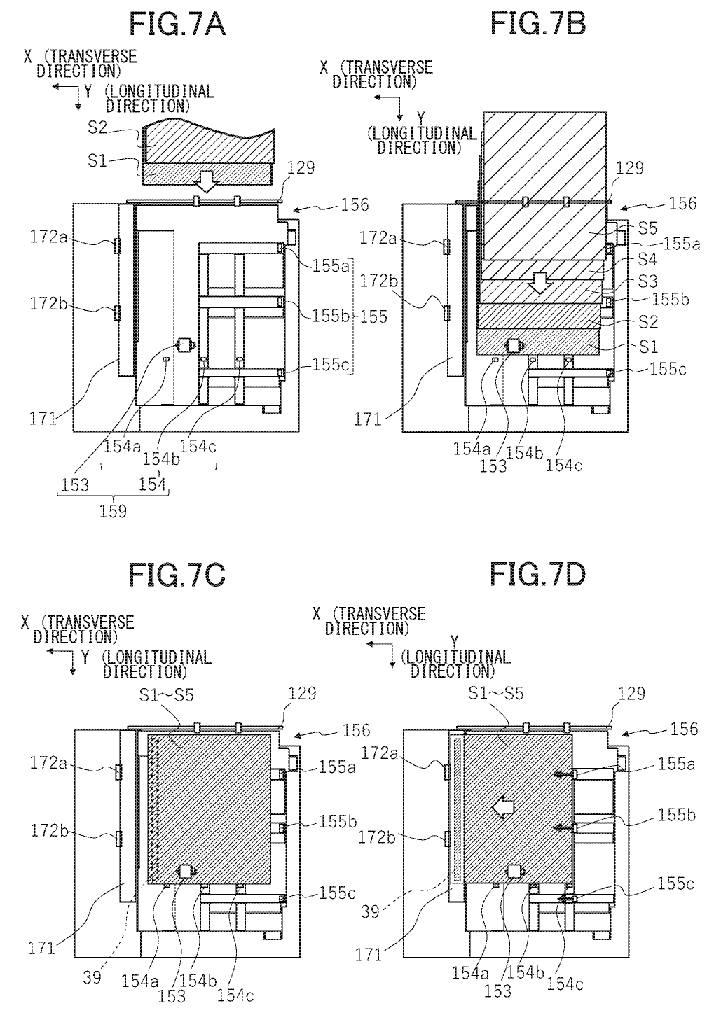

Next, an example of a configuration of the alignment section 156 will be described with reference to FIGS. 5-7D. FIG. 5 is a cross-sectional view of the alignment section 156. FIG. 6 is an exploded view of a movable unit 159 illustrating its components. FIGS. 7A-7D are schematic views of the alignment section 156 as viewed from above.

In the following description and the drawings, a moving direction when a pressurizing member of the heat-pressure bonding section 167 pressurizes the sheet bundle is defined as a Z direction. The Z direction is a height direction (thickness direction) of the sheet bundle placed on the alignment section 156. In addition, directions orthogonal to each other in a virtual plane orthogonal to the Z direction are defined as an X direction and a Y direction. If necessary, directions indicated by arrows X, Y, and Z illustrated in the drawings represent +X side, +Y side, and +Z side, respectively, and the opposite sides represent -X side, -Y side, and -Z side, respectively.

In the present embodiment, the Y direction is substantially parallel to the conveyance direction in which the sheet is conveyed to the alignment section 156 by the kick-out roller pair 129. In the present embodiment, the X direction is a sheet width direction orthogonal to the conveyance direction. In the following description, the Y direction may be referred to as "longitudinal direction", and the X direction may be referred to as "width direction" or "transverse direction".

The alignment section 156 includes a lower intermediate guide 152 on which the sheets S are stacked, an upper intermediate guide 151 facing the lower intermediate guide 152, and a movable unit 159 including a vertical alignment reference plate 154 and a vertical alignment roller 153. The lower intermediate guide 152 is a stacking portion on which a plurality of sheets S to which adhesive is applied by the image forming section 101B (application unit) are stacked.

As illustrated in FIG. 6, the vertical alignment reference plate 154 includes a plurality of sheet contact portions 154a, 154b, and 154c arranged side by side in the X direction. The sheet contact portions 154a, 154b, and 154c are reference positions for sheet alignment in the Y direction. The vertical alignment roller 153 is rotatably held by a roller holder 160. The roller holder 160 can be swung by a driving force of a solenoid 163. By swinging the roller holder 160, the vertical alignment roller 153 is movable between a position where it contacts the sheet S stacked on the lower intermediate guide 152 and conveys the sheet toward the vertical alignment reference plate 154 and a position where it is retracted upward away from the sheet S.

A drive motor 161 is attached to the movable unit 159. When a driving force of the drive motor 161 is transmitted through a gear train 162, the vertical alignment roller 153 rotates. The movable unit 159 is movable as an integrated unit in the Y direction with respect to the lower intermediate guide 152.

The alignment section 156 includes a width alignment member 155 and a drive motor 158 as illustrated in FIG. 5, and includes width alignment reference plates 172a and 172b as illustrated in FIG. 7A. The width alignment member 155 is movable in the X direction by a driving force of the drive motor 158. The width alignment member 155 includes a plurality of sheet pressing portions 155a, 155b, and 155c arranged side by side in the Y direction. As illustrated in FIG. 7A, the width alignment reference plates 172a and 172b include a plurality of plate-shaped members (sheet contact portions) arranged side by side in the Y direction. The width alignment reference plates 172a and 172b are reference positions for sheet alignment in the X direction.

### Operation of Alignment Section

An operation of the alignment section 156 will be described with reference to FIGS. 7A-7D. FIGS. 7A-7D are schematic views of the alignment section 156 as viewed from above (+Z side). The drive mechanism and the like for the upper intermediate guide 151 and the heat-pressure bonding section 167 are omitted.

In a case where a sheet bundle is aligned in the alignment section 156, the movable unit 159 is positioned at a predetermined standby position in advance in the Y direction in accordance with the sheet size. The standby position is a position where the distance in the Y direction from the nip position of the kick-out roller pair 129 to the sheet contact portions 154a to 154c of the vertical alignment reference plate 154 is slightly longer than the length of the sheet.

Hereinafter, the operation of the alignment section 156 will be described using, as an example, a case where a sheet bundle including five sheets S1 to S5 stacked in the buffer section 120 is conveyed. The number of sheets of the sheet bundle stacked in the buffer section 120 can be arbitrarily changed, and is not limited to five. Further, the alignment section 156 may load and align the sheets S conveyed one by one.

FIG. 7A illustrates a state in which the first sheet S1 and the second sheet S2 are conveyed toward the alignment section 156. The movable unit 159 (the vertical alignment reference plate 154 and the vertical alignment roller 153) has moved to the standby position corresponding to the sheet size. The width alignment member 155 stands by at a position slightly spaced outward from the side edge position of the sheet bundle so as not to disturb the conveyance of the sheet bundle.

FIG. 7B illustrates a state in which the trailing edge of the first sheet S1 has passed through the nip of the kick-out roller pair 129 and the leading edge of the sheet S1 has reached the vertical alignment roller 153. The vertical alignment roller 153 has moved down to the contact position in advance by energizing the solenoid 163, and is rotated by the drive motor 161.

The sheet S1 is conveyed to the +Y side by the vertical alignment roller 153 and abuts against the vertical alignment reference plate 154, whereby the sheet S1 is aligned in the Y direction. Thereafter, every time the trailing edges of the succeeding sheets S2 to S5 pass through the kick-out roller pair 129, the respective sheets are conveyed to the +Y side by the vertical alignment roller 153 and abut against the vertical alignment reference plate 154, whereby the sheets S1 to S5 are aligned in the Y direction.

FIG. 7C illustrates a state in which the five sheets S1 to S5 abut against the vertical alignment reference plate 154, thereby completing alignment in the Y direction. In this state, the width alignment member 155 is moved in the X direction by the driving force of the drive motor 158 (see FIG. 5). The sheets S1 to S5 are moved toward the width alignment reference plates 172a and 172b when one-side edges of sheets S1 to S5 are pressed by the sheet pressing portions 155a, 155b, and 155c of the width alignment member 155.

FIG. 7D illustrates a state in which the side edges of the sheets S1 to S5 abut against the width alignment reference plates 172a and 172b. As a result, the sheets S1 to S5 are aligned in the X direction. Thereafter, heat-pressure bonding is performed on the five sheets S1 to S5 by a heater section 171, which will be described below. In a case where a booklet including six or more sheets is produced, the alignment section 156 prepares to receive the sixth and subsequent sheets in parallel with the operation of heat-pressure-bonding the sheets S1 to S5. Specifically, the width alignment member 155 is moved in the retraction direction (-X side).

### Heat-pressure Bonding Section

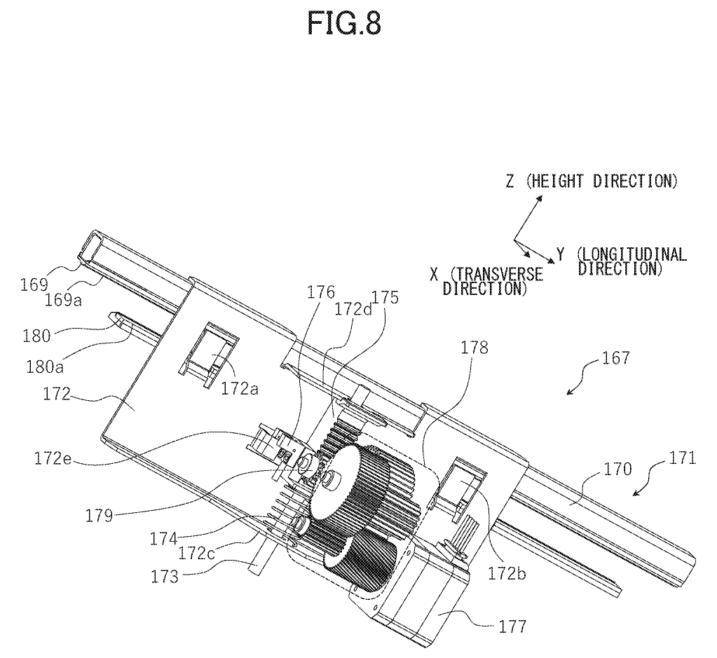

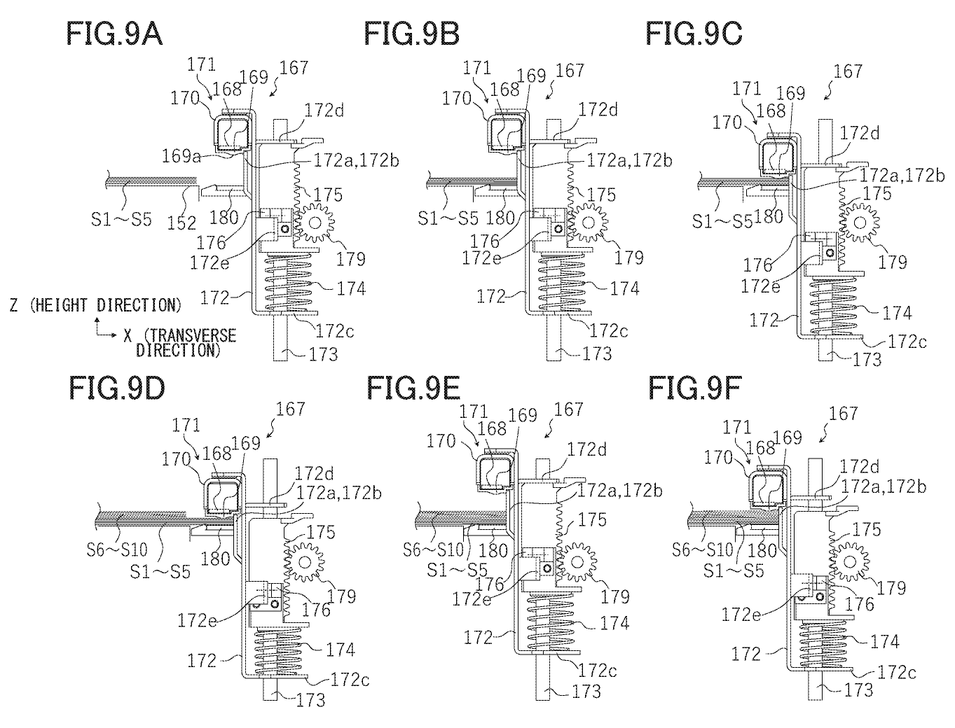

A configuration of the heat-pressure bonding section 167 according to the present embodiment will be described with reference to FIGS. 8 and 9A-9F. FIG. 8 is a perspective view of the heat-pressure bonding section 167. FIGS. 9A-9F are views of the heat-pressure bonding section 167 as viewed in the Y direction.

As illustrated in FIG. 8, the heat-pressure bonding section 167 includes a heater section 171 including a pressurizing plate 169, a receiving plate 180 facing the pressurizing plate 169, and a drive system including a motor 177. The heater section 171 including the pressurizing plate 169 is movable in the thickness direction (Z direction) of the sheet bundle placed on the lower intermediate guide 152 by a driving force of the motor 177.

The receiving plate 180 is formed of an elastic material (elastomer), and is, for example, made of silicone rubber. The receiving plate 180 is an example of a receiving member that receives a pressurizing force of the pressurizing member. The receiving plate 180 according to the present embodiment has a shape like a plate elongated in the Y direction with its thickness direction being the Z direction. The receiving plate 180 has a contact surface 180a that comes into contact with a lower surface of a sheet bundle. The contact surface 180a according to the present embodiment is a plane extending substantially perpendicular to the Z direction.

The heater section 171 includes a pressurizing plate 169, a ceramic heater 168 (see FIG. 9A), and a metal stay 170. The pressurizing plate 169 is an example of a pressurizing member that pressurizes a sheet bundle to be bonded. The ceramic heater 168 is an example of a heating unit that heats the pressurizing member.

The pressurizing plate 169 has a shape like a plate elongated in the Y direction with its thickness direction being the Z direction. The pressurizing plate 169 is made of, for example, aluminum. As illustrated in FIGS. 8 and 9A-9F, the pressurizing plate 169 has a contact surface 169a that comes into contact with an upper surface of a sheet bundle. The contact surface 169a according to the present embodiment has a cross-sectional shape in which its central portion in the X direction protrudes in a pressurizing direction (-Z side) and has a convex shape extending in the Y direction.

The heat-pressure bonding section 167 can heat-pressure-bond a sheet bundle placed on the alignment section 156 along one side extending in the Y direction using the pressurizing plate 169 extending in the Y direction. The alignment section 156 and the heat-pressure bonding section 167 according to the present embodiment can perform so-called long side binding in which a sheet of A4 size or the like is aligned in a direction (long side feeding direction) in which the long side of the sheet is parallel to the sheet conveyance direction, and heat-pressure bonding is performed in a bonding region (the bonding toner image 39 in FIG. 2) along the long side of the sheet. Note that a binding method other than the long side binding may be performed by changing the shapes of the pressurizing plate 169 and the receiving plate 180, the arrangement of the heat-pressure bonding section 167, and the like.

As illustrated in FIGS. 9A-9F, the ceramic heater 168 is a heater substrate in which a pattern of a heating resistor is formed on a ceramic substrate, and generates heat by supplying electric current to the heating resistor. The ceramic heater 168 is disposed in contact with the pressurizing plate 169. The pressurizing plate 169 and the ceramic heater 168 are held by the metal stay 170. A lift plate 172 is fixed to the metal stay 170 of the heater section 171. The lift plate 172 moves integrally with the heater section 171. In the present embodiment, the width alignment reference plates 172a and 172b described above are formed integrally with the lift plate 172 by bending some portions of the sheet metal member constituting the lift plate 172.

In addition, the heater section 171 includes a temperature detection sensor such as a thermistor for detecting a temperature of the ceramic heater 168. The control section of the post-processing apparatus 106 controls the power supply to the ceramic heater 168 according to the detection result of the temperature detection sensor, thereby controlling the surface temperature of the pressurizing plate 169 to a predetermined temperature suitable for heat-pressure bonding.

As illustrated in FIG. 8, the drive system of heat-pressure bonding section 167 includes a motor 177 serving as a drive source, a gear train 178, a pinion gear 179, and a rack gear 175. The gear train 178, the pinion gear 179, and the rack gear 175 are examples of drive transmission mechanisms that convert the rotation of the motor 177 into movement of the heater section 171 in the pressurizing direction (Z direction) and transmit the conversion to the heater section 171.

The pinion gear 179 is connected to the motor 177 via the gear train 178. The pinion gear 179 meshes with the rack gear 175. The gear train 178, the pinion gear 179, and the rack gear 175 constitute a speed reduction mechanism for obtaining a pressurizing force necessary for heat-pressure-bonding the sheet bundle. As the speed reduction mechanism, for example, a worm gear or a planetary gear mechanism may be used.

The rack gear 175 is guided by a cylindrical guide shaft 173 extending in the Z direction, and moves back and forth in the Z direction. The guide shaft 173 is fixed to the frame body of the heat-pressure bonding section 167. A compression spring 174, which is compressed when the pressurizing plate 169 pressurizes a sheet bundle, is disposed between the rack gear 175 and a lower surface 172c of the lift plate 172. When the heater section 171 is separated from the receiving plate 180 in the Z direction, the rack gear 175 abuts against an upper surface 172d of the lift plate 172 due to a biasing force of the compression spring 174.

A photointerrupter 176 is held integrally with the rack gear 175. The photointerrupter 176 detects a change in the relative position between the rack gear 175 and the lift plate 172.

The motor 177 functions as a drive source that moves the heater section 171 in the pressurizing direction (Z direction). A pinion provided on an output shaft of the motor 177 is coupled to the rack gear 175 via the gear train 178 and the pinion gear 179 so as to be able to transmit the driving force. As a result, the driving force of the motor 177 is transmitted to the rack gear 175.

When the heat-pressure bonding section 167 heat-pressure-bonds a sheet bundle, the rack gear 175 moves in the pressurizing direction (-Z side) due to a driving force transmitted from the motor 177 rotating in a predetermined direction (rotating forward). As a result, the lift plate 172 and the heater section 171 move in the pressurizing direction (-Z side), and the pressurizing plate 169 comes into contact with the sheet bundle. After the bonding processing is completed by pressurizing and heating the sheet bundle, the motor 177 rotates in a direction opposite to the heat-pressure bonding direction (rotates reversely), and the heater section 171 is separated from the sheet bundle in a direction opposite to the pressurizing direction (+Z side).

### Heat-pressure Bonding Operation

An operation (heat-pressure bonding operation) in which the heat-pressure bonding section 167 heat-pressure-bonds a sheet bundle (bonding processing) will be described with reference to FIGS. 9A-9F. Each of FIGS. 9A-9F is a view of the heat-pressure bonding section 167 as viewed in the Y direction.

FIG. 9A illustrates the same state as FIG. 7C, that is, a state in which the alignment of the sheets S1 to S5 in the Y direction is completed. At this time point, the heater section 171 is located at a position separated from the sheet bundle in the Z direction.

FIG. 9B illustrates the same state as FIG. 7D, that is, a state in which the alignment of the sheets S1 to S5 in the X direction (width direction) is completed. The sheets S1 to S5 are aligned in the X direction by abutting against the width alignment reference plates 172a and 172b.

FIG. 9C illustrates a state in which the heater section 171 moves in the pressurizing direction (-Z side) by forwardly rotating the motor 177, and the contact surface 169a of the pressurizing plate 169 comes into contact with the uppermost sheet S5.

FIG. 9D illustrates a state in which the sheets S1 to S5 are nipped between the pressurizing plate 169 and the receiving plate 180 and heat-pressure bonding of the sheets S1 to S5 is being performed as the motor 177 continues to be driven further from the time point of FIG. 9C. The compression spring 174 is compressed by being pushed by the lower surface of rack gear 175, increasing the repulsive force of compression spring 174. The repulsive force of the compression spring 174 is applied to the pressurizing plate 169 via the lift plate 172 and the heater section 171, whereby the sheets S1 to S5 are pressurized by the pressurizing plate 169. The motor 177 is controlled to stop at a timing when it has rotated forward by a predetermined rotation amount after the photointerrupter 176 is blocked by a rib 172e of the lift plate 172. As a result, the force of the pressurizing plate 169 for pressurizing the sheet bundle can be adjusted to a predetermined target value.

FIG. 9D illustrates a state in which next sheets S6 to S10 are conveyed to the alignment section 156 in parallel with the heat-pressure bonding of the sheets S1 to S5.

FIG. 9E illustrates a state in which, after the heat-pressure bonding of the sheets S1 to S5 is completed, the heater section 171 moves (retracts) toward a side (+Z side) opposite to the pressurizing direction by reversely rotating the motor 177, and the pressurizing plate 169 is separated from the sheet S5. In addition, FIG. 9E illustrates a state in which the next sheets S6 to S10 are aligned, and the sheets S1 to S5 abut against the width alignment reference plates 172a and 172b after the retraction of the heater section 171.

FIG. 9F illustrates a state in which the heater section 171 moves again in the pressurizing direction (-Z side) by forwardly rotating the motor 177, the sheets S1 to S10 are nipped between the pressurizing plate 169 and the receiving plate 180, and the heat-pressure bonding of the sheets S6 to S10 is being performed. The motor 177 is controlled to stop at a timing when it has rotated forward by a predetermined rotation amount after the photointerrupter 176 is blocked by a rib 172e of the lift plate 172. As a result, the working length of the compression spring 174 can be made the same between when the sheets S1 to S5 are heat-pressure-bonded in FIG. 9D and when the sheets S6 to S10 are heat-pressure-bonded in FIG. 9F. That is, regardless of the thickness of the sheet bundle placed on the lower intermediate guide 152 (stacking portion), the pressurizing force applied for heat-pressure-bonding the sheet bundle can be made substantially constant. Further, since a bonding toner image is formed on at least one of the upper surface of the sheet S5 and the lower surface of the sheet S6, the sheet bundle including the sheets S1 to S5 and the sheet bundle including the sheets S6 to S10 are bonded to each other. As a result, a booklet Bk including ten sheets S1 to S10 is formed.

In this manner, the heat-pressure bonding section 167 performs a heat-pressure bonding operation once every time a bundle of a predetermined number of sheets is aligned by the alignment section 156, thereby making it possible to produce a booklet including a larger number of sheets than the maximum number of sheets that can be stacked at a time by the buffer section 120. Here, the example in which the booklet Bk including ten sheets S1 to S10 is produced has been described, but a booklet including ten or more sheets can also be produced. In addition, although the sequence in which the heat-pressure bonding operation is performed for every predetermined number of sheets has been described, two sheets may be heat-pressure-bonded first, and thereafter, a heat-pressure bonding operation may be performed for every sheet. That is, the frequency at which the heat-pressure bonding section 167 performs the heat-pressure bonding operation can be changed.

In addition, although the operation of making the pressurizing force applied for heat-pressure bonding constant has been described, the pressurizing force applied for heat-pressure bonding may be changed depending on the characteristics of the heat-pressure bonding section, the characteristics of the sheets to be used, and the number of sheets to be used. For example, in a case where the heat-pressure bonding operation is performed multiple times in order to produce one booklet, the pressurizing force applied for heat-pressure bonding may be increased initially. In addition, for example, in a case where the heat-pressure bonding operation is performed multiple times to produce one booklet, the pressurizing force may be increased as the thickness of the sheet bundle on the lower intermediate guide 152 increases. According to the configuration of the present embodiment, the pressurizing force applied for heat-pressure bonding can be changed by adjusting the amount of rotation to increase or decrease from when the photointerrupter 176 is blocked by the rib 172e until the motor 177 is stopped.

### Bundle Discharge Operation

When the heat-pressure bonding operation for all the sheets constituting one booklet is completed, the booklet including the sheets S1 to S10 is extruded from the alignment section 156 by the vertical alignment reference plate 154. The booklet extruded from the alignment section 156 is conveyed in a direction (-Y side) toward a bundle discharge roller pair 136 (see FIG. 1) via the sheet discharge conveyance path 138. In other words, the vertical alignment reference plate 154 also functions as an extrusion member that extrudes the sheet bundle from the alignment section 156 and the heat-pressure bonding section 167. In addition to the vertical alignment reference plate 154 serving as a reference for aligning the sheet positions, an extrusion member that extrudes the processed sheet bundle from the alignment section 156 and the heat-pressure bonding section 167 may be provided.

The bundle discharge roller pair 136 is a pair of rollers that can be opened and closed (contactable and separable), and receives a booklet from the sheet discharge conveyance path 138 in the separated state. After the leading edge of the booklet extruded by the vertical alignment reference plate 154 passes the position of the bundle discharge roller pair 136, the movement of the vertical alignment reference plate 154 is stopped, and the bundle discharge roller pair 136 is switched to the contact state. Thereafter, the booklet is nipped and conveyed by the bundle discharge roller pair 136, and discharged to the lower sheet discharge tray 137. On the other hand, the vertical alignment reference plate 154 returns to the standby position again after delivering the booklet to the bundle discharge roller pair 136.

### Bonding Strength and Booklet Strength

Here, the meanings of the terms "bonding strength" and "booklet strength" used herein will be described.

The “bonding strength” refers to a strength with which two sheets adjacent to each other are bonded by a layer of bonding toner (bonding layer) interposed between the two sheets. In the present embodiment, the bonding toner serving as adhesive is heated and pressurized by the heat-pressure bonding operation of the heat-pressure bonding section 167, whereby the stacked sheets are bonded to one another via the layer of bonding toner. As will be described in detail below, the bonding strength is measured as a force required to peel apart two bonded test pieces (strip-shaped sheets). The bonding strength can be rephrased as a magnitude of a force (bond peeling strength) required to peel apart two bonded sheets.

A structure formed by the layer of bonding toner interposed between overlapping two sheets and surface regions (bonding regions) of the respective sheets facing each other with the layer of bonding toner interposed therebetween is hereinafter referred to as “bonding portion”. The bonding strength is represented by a peeling load per unit width of the bonding portion between the test pieces, and the unit of bonding strength is N/cm. The unit width of the bonding portion is a unit length (e.g., 1 cm) of the bonding portion in a direction orthogonal to the peeling progress direction. It is known that when the amount of bonding toner per unit area in the bonding portion increases, the bonding strength increases.

The “booklet strength” is a force required to peel the booklet apart between certain pages. The booklet strength can be rephrased as a magnitude of a force (bond peeling strength) required to peel the booklet apart between a pair of adjacent sheets in the booklet to which a plurality of sheets are bonded. The booklet strength can be referred to as a measurement value of bond peeling strength measured when any two sheets stacked on one another in the booklet are peeled apart (alternatively, a set of measurement values of bond peeling strength measured for all pairs of sheets stacked on one another in the booklet). The unit of booklet strength is N.

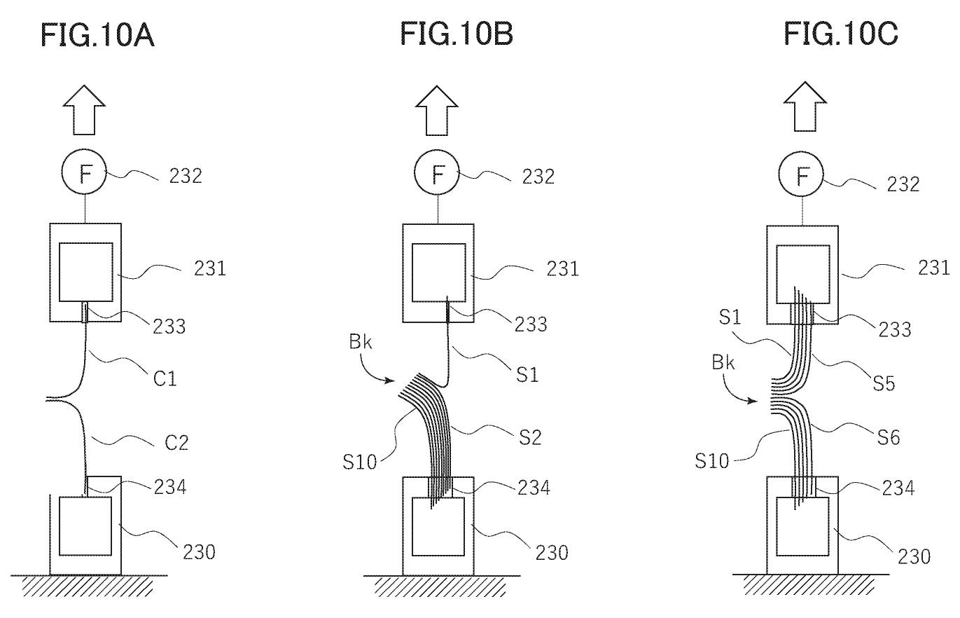

Methods of measuring a bonding strength and a booklet strength will be described with reference to FIGS. 10A-10C. As illustrated in FIGS. 10A-10C, a fixed clamper 230 is fixed to the ground, and a movable clamper 231 is configured to be movable in the vertical direction by a guide mechanism (not illustrated). The fixed clamper 230 includes a fixed-side gripping portion 234 that grips a sheet or a sheet bundle. The movable clamper 231 includes a movable-side gripping portion 233 that grips a sheet or a sheet bundle. In addition, a load measuring device 232 is connected to the movable clamper 231. The load measuring device 232 measures a load applied to the movable-side gripping portion 233.

First, the method of measuring the bonding strength will be described with reference to FIG. 10A. In this case, two strip-shaped sheets C1 and C2, which are test pieces of which one side edge portions in the long side direction are bonded to each other, are used. The non-bonding edge portion of one strip-shaped sheet C1 is gripped by the movable-side gripping portion 233, and the non-bonding edge portion of the other strip-shaped sheet C2 is gripped by the fixed-side gripping portion 234. The width (the short side length and the length in the paper depth direction of the drawing) of the strip-shaped sheets C1 and C2 is set in advance (e.g., 10 mm).

The movable clamper 231 is moved vertically upward from the state illustrated in FIG. 10A. Eventually, the bonding portion between the strip-shaped sheets C1 and C2 starts to be peeled apart from its edge portion, and the bonding portion is destroyed. The edge portion of the bonding portion that is a starting point of the destruction is an edge portion closer to the portions of the strip-shaped sheets C1 and C2 gripped by the movable clamper 231 and the fixed clamper 230, that is, an edge portion on the right side in the drawing of the bonding portion. A value obtained by dividing a maximum value, among values read by the load measuring device 232 from when the strip-shaped sheets C1 and C2 start to be peeled apart until the strip-shaped sheets C1 and C2 are completely peeled apart (from when the bonding portion starts to be destroyed until the bonding portion is completely destroyed), by the width of the bonding portion is taken as a measurement value of bonding strength between the test pieces. The width of the bonding portion is a length of the bonding portion in the paper depth direction of the drawing. As can be seen from the above-described calculation method, the unit of bonding strength is N/cm. It may be preferable to take an average of measurement values for a plurality of sets of test pieces. In this manner, a value of force (peeling load) per unit width of the bonding portion, which is measured while eliminating factors such as the stiffness of the sheet and the difference in posture between the sheets in the vicinity of the bonding portion as much as possible, is taken as the bonding strength.

Next, a method of measuring a booklet strength using the booklet Bk (so-called long side binding booklet) in which ten sheets S on which the bonding toner images 39 illustrated in FIG. 2 are formed are stacked and bonded will be described with reference to FIGS. 10B and 10C. FIG. 10B illustrates a state in which only the sheet S1 of the booklet Bk including the ten sheets S1 to S10 is gripped by the movable-side gripping portion 233 and the other sheets S2 to S10 are collectively gripped by the fixed-side gripping portion 234. At this time, the gripping position in the long side direction of the booklet Bk (the paper depth direction of the drawing) is arranged at the central portion of the long side of the booklet Bk or evenly along substantially the entire long side.

The movable clamper 231 is moved vertically upward from the state illustrated in FIG. 10B. Eventually, the booklet Bk starts to be peeled apart from an edge portion of the bonding portion between the sheets S1 and S2, and the bonding portion is destroyed. The edge portion of the bonding portion that is a starting point of the destruction is an edge portion closer to the portions of the booklet Bk gripped by the movable clamper 231 and the fixed clamper 230, that is, an edge portion on the right side in the drawing of the bonding portion. A maximum value, among values read by the load measuring device 232 from when the sheets S1 and S2 start to be peeled apart until the sheets S1 and S2 are completely peeled apart (from when the bonding portion starts to be destroyed until the bonding portion is completely destroyed), is defined as a booklet strength between the sheets S1 and S2. As can be seen from this calculation method, the unit of booklet strength is N (Newton).

FIG. 10C illustrates a state in which the sheets S1 to S5 of the same booklet Bk as described above are collectively gripped by the movable-side gripping portion 233, and the sheets S6 to S10 are collectively gripped by the fixed-side gripping portion 234. When the movable clamper 231 is moved vertically upward from the state illustrated in FIG. 10C, the booklet Bk eventually starts to be peeled apart from an edge portion of the bonding portion between the sheets S5 and S6, and the bonding portion is destroyed. The edge portion of the bonding portion that is a starting point of the destruction is an edge portion closer to the portions of the booklet Bk gripped by the movable clamper 231 and the fixed clamper 230, that is, an edge portion on the right side in the drawing of the bonding portion. A maximum value, among values read by the load measuring device 232 from when the sheets S5 and S6 start to be peeled apart until the sheets S5 and S6 are completely peeled apart (from when the bonding portion starts to be destroyed until the bonding portion is completely destroyed), is defined as a booklet strength between the sheets S5 and S6.

As will be described below, the result of measuring the booklet strength also varies depending on the stiffness of the sheets S1 to S10 constituting the booklet Bk and the postures of the sheets in the vicinity of the bonding portion. The postures of the sheets in the vicinity of the bonding portion refers to orientations of the sheets in the bonding portion and curvatures of the sheets in the vicinity of the bonding portion. The measurement value of bond peeling strength including these factors is taken as the booklet strength.

### Relationship Between Amount of Bonding Toner and Booklet Strength

A relationship between an amount of bonding toner interposed between a pair of adjacent sheets in the booklet Bk and bonding strength will be described. The bonding toner interposed between a pair of adjacent sheets refers to a toner interposed between any two sheets superimposed in the alignment section 156, resulting from the bonding toner image 39 having been formed on at least one of the two sheet surfaces facing each other. The amount of bonding toner interposed between the stacked sheets is the sum of the amount per unit area of the bonding toner image formed in the bonding region of one of the two sheets to be bonded and the amount per unit area of the bonding toner image formed in the bonding region of the other sheet. The unit of the amount of bonding toner is, for example, μg/mm².

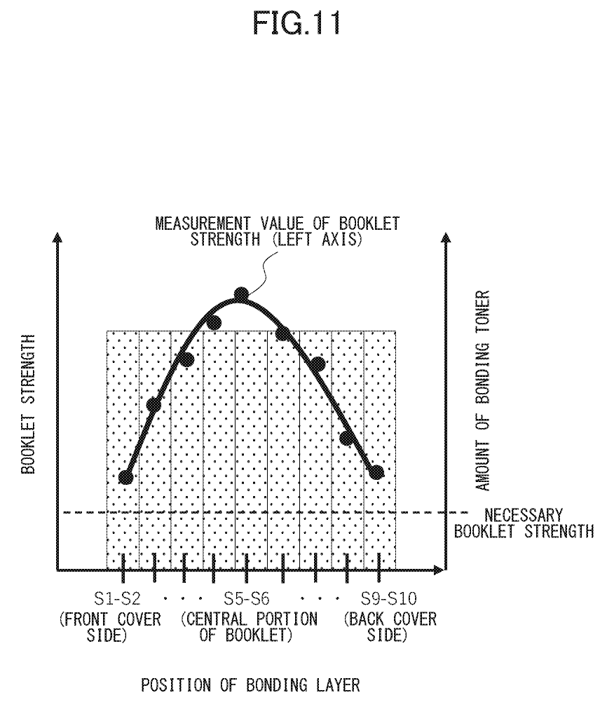

FIG. 11 schematically illustrates a booklet strength (polygonal line: left vertical axis) and an amount of bonding toner per unit area (bar graph: right vertical axis) for each of positions of bonding layers (horizontal axis) included in a booklet Bk including ten sheets S1 to S10 in a comparative example. The position of the bonding layer is indicated by the reference signs for the adjacent two sheets with the bonding layer interposed therebetween. That is, S1-S2 denotes a bonding layer formed between the sheet S1 and the sheet S2. In this comparative example, it is assumed that the amount of bonding toner per unit area is the same between the bonding layers. In this case, when booklet strengths are measured in the respective bonding layers, the booklet strengths tend to be distributed as indicated by the polygonal line in FIG. 11.

That is, in the comparative example, the booklet strength between sheets located at the central portion of the booklet is higher than the booklet strength between sheets located at a position close to a front cover (S1) or a back cover (S10) in the thickness direction of the booklet. This is because, at the central portion of the booklet, a large area of the bonding portion between the sheets S5 and S6 receives a force to peel the sheets S5 and S6 apart due to the stiffness of the sheets S1 to S10. Since a large area of the bonding portion receives a force to peel the sheets S5 and S6 apart, the stress is dispersed, thereby making it difficult to destroy the bonding portion.

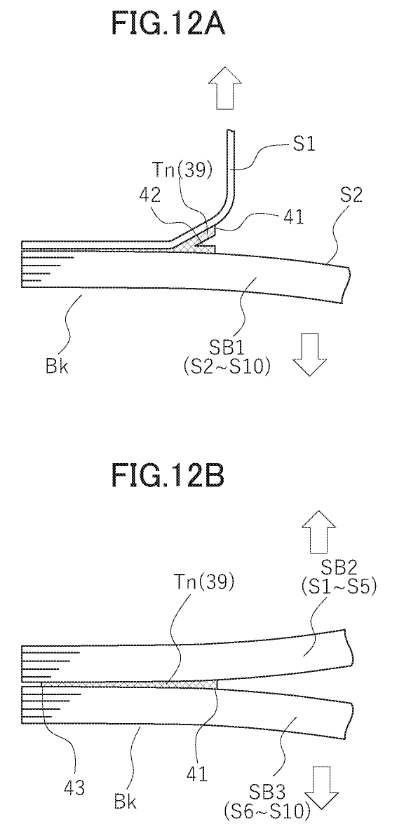

A mechanism by which the booklet strength increases at the central portion of the booklet will be described in detail with reference to FIGS. 12A and 12B. FIG. 12A is a cross-sectional view illustrating a state in the middle of peeling apart the booklet Bk between the sheets S1 and S2, and illustrates the vicinity of the bonding portion between the sheets S1 and S2. FIG. 12B is a cross-sectional view illustrating a state in the middle of peeling apart the booklet Bk between the sheets S5 and S6, and illustrates the vicinity of the bonding portion between the sheets S5 and S6. The hatched region in the drawing is a bonding layer Tn (bonding toner layer) formed by pressurizing and heating the bonding toner image 39 (FIG. 2).

The sheet S1 in FIG. 12A is a sheet (front cover or back cover) located on an outer surface of the booklet Bk, and is being peeled apart from a sheet bundle SB1 including the other nine sheets S2 to S10. The sheets S5 and S6 in FIG. 12B are both located inside the outer surface of the booklet Bk. In FIG. 12B, a sheet bundle SB2 including the sheets S1 to S5 and a sheet bundle SB3 including the sheets S6 to S10 are being peeled apart. FIG. 12A corresponds to the situation in FIG. 10B, and FIG. 12B corresponds to the situation in FIG. 10C.

Hereinafter, a sheet (front cover or back cover) located on an outer surface of the booklet Bk is referred to as a sheet at the outermost position. When the booklet Bk includes N sheets (N≥3), the sheets at the outermost positions are the first sheet and the N-th sheet in the thickness direction of the booklet Bk. The (N-2) sheets of the booklet Bk other than the sheets at the outermost positions are located inside the outermost positions in the thickness direction of the booklet Bk. In addition, in a case where the booklet Bk includes an even number of sheets (2M sheets), the "center of the booklet" in the thickness direction of the booklet Bk refers to a position between the M-th sheet and the (M+1)-th sheet from the front cover. In addition, the "center of the booklet" refers to the (M+1)-th sheet from the front cover when the booklet Bk includes odd-numbered sheets (2M+1 sheets). The “central portion of the booklet” refers to a portion including the center of the booklet Bk and not including the sheets at the outermost positions of the booklet Bk (e.g., a central part when the booklet is divided into three equal parts in the thickness direction).

As illustrated in FIG. 12A, when the sheet S1 located at the outermost position is pulled, peeling stress (tensile stress in the up-down direction of the drawing) is concentrated at an edge portion 41 of the bonding layer Tn. This is because the stiffness of one sheet S1 is low, and thus the sheet S1 is curved in the vicinity of the bonding portion. The bonding layer Tn slightly elongates due to the peeling stress. While the amount of elongation remains below the limit, the bonding layer Tn withstands without being destroyed, but when the amount of elongation exceeds the limit, a crack 42 occurs inside the bonding layer Tn. When the crack 42 occurs, the orientation of the sheet S1 in the vicinity of the crack 42 changes such that the sheet S1 moves away from the sheet bundle SB1 as it moves from the leading edge of the crack 42 toward the edge portion 41 of the bonding layer Tn. Then, stress is concentrated at the leading edge of the crack 42, causing fracture to progress rapidly. In this manner, when the sheet S1 located at the outermost position is peeled apart, stress is concentrated at a part of the bonding layer Tn because the stiffness of the sheet S1 is low, resulting in a tendency toward a decrease in booklet strength.

On the other hand, as illustrated in FIG. 12B, in a case where the sheet bundles SB2 and SB3 are peeled apart from each other between the sheets S5 and S6 at the central portion of the booklet Bk, stress concentration hardly occurs. That is, each of the sheet bundles SB2 and SB3, which includes a plurality of sheets bonded via the bonding layer Tn, has higher stiffness than one sheet S1, and behaves like a plate. Therefore, unlike the case where the sheet S1 located at the outermost position is pulled, the sheet bundles SB2 and SB3 are curved gently in the vicinity of the bonding portion.

In this case, even if the sheet bundles SB2 and SB3 are pulled in the up-down direction of the drawing, tensile stress acts over a wide range of the bonding layer Tn, and the concentration of the tensile stress on the edge portion 41 of the bonding layer Tn is alleviated. That is, the bonding layer Tn can receive a tensile force over a wide range from the edge portion 41 of the bonding layer Tn on the side where the sheet bundles SB2 and SB3 are opened apart by a tensile tester of FIGS. 10A-10C to an edge portion 43 of the bonding layer Tn on the opposite side. Therefore, under the condition where the load of the tensile tester is the same, smaller tensile stress acts on the edge portion 41 of the bonding layer Tn in the case of FIG. 12B than in the case of FIG. 12A. As a result, the crack 42 is less likely to occur in the bonding layer Tn, and the bonding layer Tn is less likely to be destroyed. That is, when the sheets S5 and S6 located inside the outermost positions are peeled apart, stress is hardly concentrated at a part of the bonding layer Tn because the stiffness of the sheet bundles SB2 and SB3 is high, resulting in a tendency toward an increase in booklet strength.

However, the booklet strength also varies depending on factors other than the positions of the sheets in the booklet Bk. For example, the materials of the sheets S1 and S10 located at the outermost positions may be different from the materials of the sheets S2 to S9 located inside the outermost positions. In this case, the booklet strength of the sheets S1 and S10 located at the outermost positions tends to be stronger (or weaker) than the booklet strength of the sheets located inside the outermost positions due to a difference in bonding strength caused by the compatibility between the bonding toner and the material of the sheet.

### Control of Amount of Bonding Toner

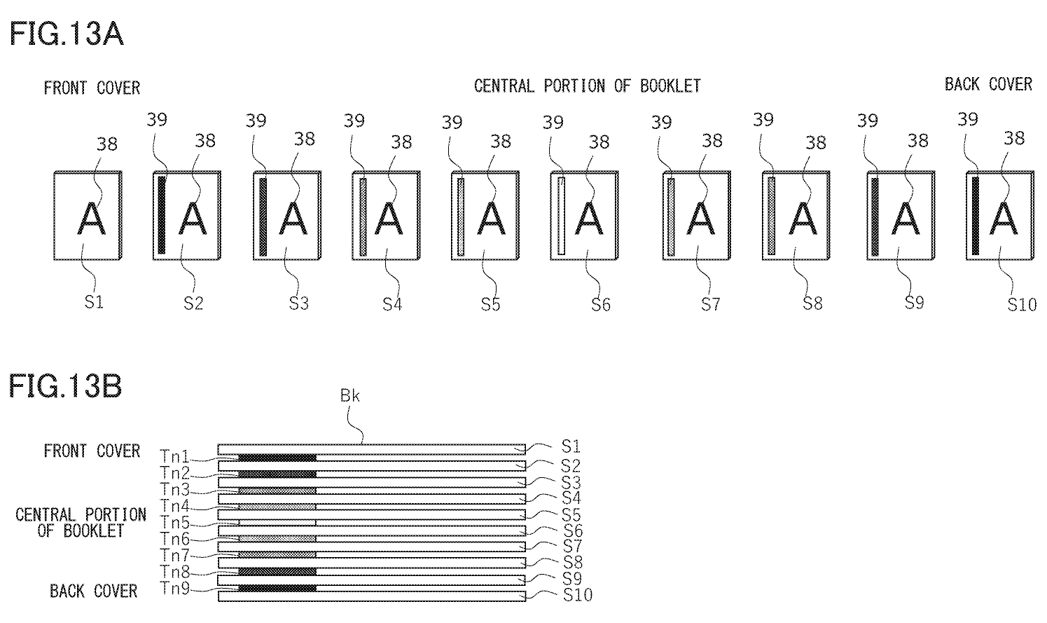

An example in which the amount of bonding toner is controlled according to the present embodiment will be described with reference to FIGS. 13A and 13B. In FIG. 13A, the sheets S1 to S10 on which the bonding toner images 39 have been formed before being bonded to each other are schematically arranged side by side in a horizontal row. FIG. 13B is a schematic view illustrating a cross section in the thickness direction D1 of the booklet Bk in which the sheets S1 to S10 of FIG. 13A are stacked and bonded. The sheet S1 is a front cover of the booklet Bk, and the sheet S10 is a back cover of the booklet Bk.

In the example illustrated in FIG. 13A, only the recording toner image 38 is formed on the sheet S1. Both the recording toner image 38 and the bonding toner image 39 are formed on each of the sheets S2 to S10.

As illustrated in FIG. 13B, when the sheets S1 to S10 are stacked, the bonding toner image 39 formed for each pair of adjacent sheets on one of the pair of adjacent sheets is interposed between the two sheets. For example, the bonding toner image 39 formed on the second sheet is interposed between the first and second sheets S1 and S2. In addition, the bonding toner images 39 are softened by the heat-pressure bonding operation of the heat-pressure bonding section 167 described above and then are solidified, thereby forming bonding layers Tn1 to Tn9 that bridge the facing surfaces of the stacked sheets.

In FIGS. 13A and 13B, the density of hatching applied to the bonding toner images 39 and the bonding layers Tn1 to Tn9 indicates an amount of bonding toner per unit area. That is, the darker the hatching color, the larger the amount of toner per unit area, and the lighter the hatching color, the smaller the amount of toner per unit area. In the present embodiment, the toner-applied amount of the bonding toner image 39 is controlled such that the closer to the outermost position of the booklet Bk in the thickness direction D1 of the booklet Bk, the larger the amount of bonding toner per unit area, and the closer to the central portion of the booklet, the smaller the amount of bonding toner per unit area. That is, the amount of bonding toner per unit area in the bonding layer is different even in one booklet Bk depending on the positions of the bonding layers Tn1 to Tn9 in the thickness direction D1 of the booklet Bk.

In other words, a layer of adhesive formed between the first sheet located at the outermost position of the booklet in the thickness direction of the booklet and the second sheet adjacent to the first sheet is defined as a first bonding layer, and a layer of adhesive closer to the center of the booklet in the thickness direction than the first bonding layer is to the center of the booklet is defined as a second bonding layer. In this case, the amount of adhesive per unit area in the first bonding layer is larger than the amount of adhesive per unit area in the second bonding layer.

In the present embodiment, bonding toner images 39 are formed so that the bonding toner is uniformly distributed in the bonding regions of the sheets S2 to S10. That is, the bonding toner image 39 is a solid toner image or a halftone toner image. Here, the halftone refers to a pattern of fine dots (halftone dots) that are difficult to identify with the naked eye. In the present embodiment, the amount of bonding toner per unit area is changed by changing the thickness of the layer of bonding toner applied onto the sheet.

In other words, the control section 131 according to the present embodiment causes the image forming section 101B (application unit) to uniformly apply the adhesive over a predetermined region (bonding region) of the sheet. In addition, the control section 131 according to the present embodiment changes the amount of adhesive per unit area in the bonding layer of the produced booklet by changing the amount of adhesive adhering to the predetermined region per unit area within the predetermined region (that is, the toner-applied amount). In the present embodiment, it can be said that the amount of adhesive per unit area of the bonding layer in the produced booklet is changed by changing the toner-applied amount (the density of the bonding toner image) within the bonding region of the sheet.

In the present embodiment, a toner is used as adhesive, and the image forming section 101B (application unit) forms a toner image using the toner in a predetermined region (bonding region) where a pair of adjacent sheets in the booklet are bonded to each other, on at least one of two facing surfaces of the pair of adjacent sheets. Therefore, the amount of adhesive per unit area in the bonding layer of the produced booklet is a value obtained by dividing the total mass of the toner applied on the two surfaces within the predetermined region by the area of the predetermined region.

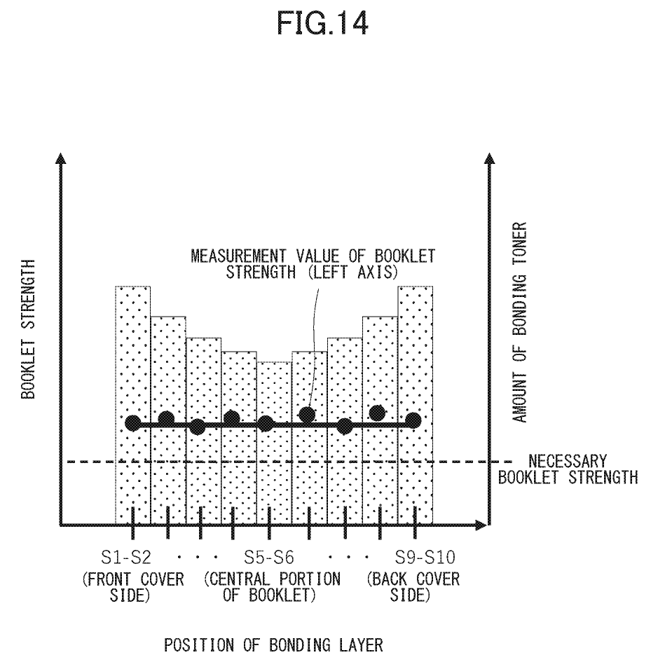

FIG. 14 schematically illustrates a booklet strength (polygonal line: left vertical axis) and an amount of bonding toner per unit area (bar graph: right vertical axis) for each of positions of bonding layers (horizontal axis) included in a booklet Bk including ten sheets S1 to S10 in the present embodiment. In the present embodiment, as described above, the closer to the outermost position of the booklet Bk the bonding layer is, the greater the amount of bonding toner is, and the closer to the central portion of the booklet Bk the bonding layer is, the smaller the amount of bonding toner is. In other words, the control section 131 according to the present embodiment controls the image forming section 101B (application unit) such that the closer to the center of the booklet in the thickness direction the layer of adhesive is, the smaller the amount of adhesive per unit area is.

When the booklet strength of the booklet Bk is measured, the booklet strength is distributed as indicated by the polygonal line in FIG. 14. When the booklet Bk is produced, it may be preferable that the booklet strength for each bonding layer included in the booklet Bk is equal to or higher than a predetermined necessary booklet strength. Here, the necessary booklet strength refers to a target value or a required value of booklet strength that has been considered in advance so that the bonding portion is not easily peeled apart when the user handles the booklet. The amount of bonding toner for each bonding layer included in one booklet Bk can be reduced within a range that does not fall below the necessary booklet strength. That is, according to the present embodiment, it is possible to minimize the amount of bonding toner consumed when producing the booklet Bk while satisfying the necessary booklet strength in one entire booklet Bk.

The necessary booklet strength can be considered as, for example, a strength with which bonding between sheets is not peeled apart even when the central portion (bonding portion) of the booklet spread-open is pressed so as to form a fold, such that two sheets are kept in a 180° open state in which the booklet is spread open. The necessary booklet strength can also be considered as, for example, a strength with which bonding between sheets is not peeled apart even when a certain sheet of the booklet is pinched and the other sheets are held so as to hang down under their own weight. The necessary booklet strength may vary depending on the application of the booklet, and is not limited to the above-described two examples.

In both the comparative example of FIG. 11 and the example of FIG. 14 to which the present embodiment is applied, the booklet strength satisfies the necessary booklet strength. However, the amount of bonding toner in the vicinity of the central portion of the booklet Bk is set to be smaller in the present embodiment than in the comparative example, while satisfying the necessary booklet strength. Therefore, according to the present embodiment, it is possible to reduce the amount of bonding toner consumed for producing one booklet Bk, while satisfying the same necessary booklet strength, as compared with the case where the amount of bonding toner is kept constant.

In general, the greater the amount of bonding toner per unit area, the stronger the bonding strength between sheets. Therefore, intuitively, the amount of bonding toner satisfying the necessary booklet strength may be determined in advance, and a constant amount of bonding toner may be applied onto the sheets regardless of the positions of the bonding portions in the booklet Bk as in the comparative example (FIG. 11). For example, the amount of bonding toner to be applied onto the sheets may be determined in advance based on conditions such as the bonding strength measured by a peeling test (see FIG. 10A) for test pieces using two sheets and the sizes of the bonding toner images 39 to be formed on the sheets for producing a booklet. However, in this configuration, as illustrated in FIG. 11, an excessive amount of bonding toner is applied in the vicinity of the central portion of the booklet Bk as compared with the amount of bonding toner necessary for realizing the necessary booklet strength.

On the other hand, the present embodiment focuses on the fact that in an actual booklet Bk, the booklet strength (peeling strength) varies depending on the position of the bonding portion in the thickness direction of the booklet Bk, unlike the result expected from the peeling test using two sheets. That is, when the amount of bonding toner is constant, the booklet strength (peeling strength) increases from the outermost position toward the central portion of the booklet Bk based on the mechanism described above. Therefore, in the present embodiment, the amount of bonding toner at the central portion of the booklet is set to be smaller than the amount of bonding toner at the outermost position of the booklet. As a result, it is possible to reduce the amount of bonding toner consumed for producing one booklet Bk, while satisfying the same necessary booklet strength, as compared with the case where the amount of bonding toner is kept constant. In addition, if the consumption amount of bonding toner can be reduced, the running cost can be reduced.

In this manner, according to the present embodiment, it is possible to provide a booklet producing apparatus and an image forming apparatus capable of reducing the consumption amount of adhesive while suppressing the decrease in the peeling strength of the booklet.

In particular, according to the present embodiment, the image forming section 101B (application unit) is controlled such that the closer to the central portion of the booklet Bk, the smaller the amount of bonding toner. As a result, it is possible to suppress a change in booklet strength with respect to the position in the thickness direction of the booklet Bk. That is, in a case where the necessary booklet strength is constant in one booklet Bk, the consumption amount of bonding toner can be minimized while satisfying the necessary booklet strength.

Although FIG. 14 illustrates an example in which the necessary booklet strength is set to a constant value regardless of the position in the booklet Bk, the necessary booklet strength may be set to a different value depending on the position in the booklet Bk. For example, in a case where a plurality of sheets constituting one booklet Bk are different in grammage, stiffness, material, size, or the like, the necessary booklet strength can be set to a different value depending on the position in the booklet Bk. Even in the same booklet, the necessary booklet strength may be different depending on the booklet peeling-away direction.

### Modification

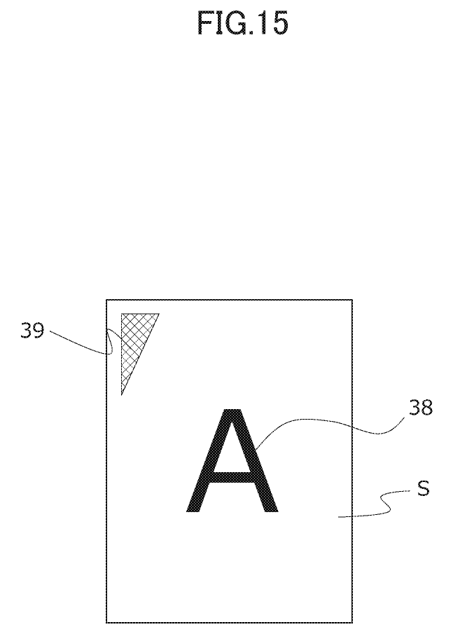

FIG. 15 illustrates a modification of the present embodiment. As illustrated in FIG. 15, in the present modification, a bonding toner image 39 is formed at a corner portion of the sheet S. This bonding toner image 39 enables processing (corner binding) of binding sheets S to each other at corner portions. That is, in the present modification, the bonding region where the bonding toner image 39 is applied onto the sheet S has a shape like a right-angled triangle close to one of the four corners of the sheet S.

In the present modification as well, the amount of bonding toner is different even in one booklet Bk depending on the position of the bonding portion in the thickness direction D1 of the booklet Bk. For example, the image forming section 101B (application unit) is controlled such that the closer to the outermost position of the booklet Bk in the thickness direction D1 of the booklet Bk, the larger the amount of bonding toner, and the closer to the central portion of the booklet Bk, the smaller the amount of bonding toner. As a result, it is possible to reduce the consumption amount of adhesive while suppressing a decrease in peeling strength of the booklet.

In both the long side binding illustrated in FIG. 2 and the corner binding illustrated in FIG. 15, the amount of bonding toner may be changed depending on conditions such as the type and size of sheets to be used and the number of sheets constituting one booklet. Specifically, the amount of bonding toner in the entire booklet may be increased or decreased according to the above-described conditions, while maintaining the configuration in which the closer to the central portion of the booklet Bk, the smaller the amount of bonding toner. Furthermore, depending on the above-described conditions, the gradient of change in which the closer to the central portion of the booklet Bk, the smaller the amount of bonding toner may be changed.

### Second Embodiment

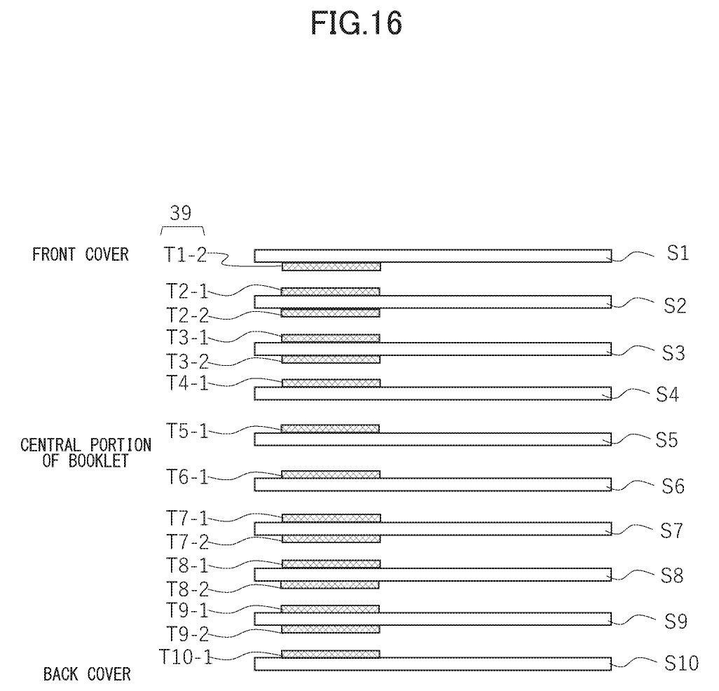

A configuration of an image forming apparatus 100 (booklet producing apparatus) according to the second embodiment will be described with reference to FIG. 16. Hereinafter, in the description of the present embodiment, unless otherwise specified, elements denoted by the same reference signs as those in the first embodiment have basically the same configurations and operations as those described in the first embodiment, and differences from the first embodiment will be mainly described.

FIG. 16 is a schematic view illustrating a cross section in the thickness direction D1 of the booklet Bk in which the sheets S1 to S10 are stacked and bonded, similarly to FIG. 13B. The sheet S1 is a front cover of the booklet Bk, and the sheet S10 is a back cover of the booklet Bk.

In the present embodiment, an image forming operation for double-sided printing is executed for each of the sheets S1 to S10. Therefore, the printer body 101 can form bonding toner images 39 on one side or both sides of each of the sheets S1 to S10.

In the example illustrated in FIG. 16, in a predetermined number of sheets inward from the outermost position of the booklet Bk, the bonding toner images 39 are formed on both of the two facing surfaces of each pair of adjacent sheets. Specifically, bonding toner images T1-2 and T2-1 are formed on facing surfaces of the sheet S1 located at the outermost position and the sheet S2. Bonding toner images T2-2 and T3-1 are also formed on facing surfaces of the sheets S2 and S3. Similarly, bonding toner images T3-2, T4-1, T7-2, T8-1, T8-2, T9-1, T9-2, and T10-1 are also formed on facing surfaces of the sheets S3 and S4, facing surfaces of the sheets S7 and S8, and facing surfaces of the sheets S9 and S10.

Therefore, the amount of bonding toner per unit area in a bonding layer between the sheet S1 and the sheet S2 is the sum of the application amount of bonding toner applied onto the sheet S1 by the image forming section 101B and the application amount of bonding toner applied onto the sheet S2 by the image forming section 101B. The application amount of bonding toner interposed between pages of two adjacent sheets among the sheets S7 to S10 is the sum of the application amounts of bonding toner applied onto the pages of the two adjacent sheets by the image forming section 101B.

On the other hand, a bonding layer located at the central portion of the booklet Bk is formed by a bonding toner image 39 formed on only one of the two facing surfaces of each pair of adjacent sheets. Specifically, no bonding toner image is formed on a surface of the sheet S4 facing the sheet S5, and a bonding layer between the sheets S4 and S5 is formed only by a bonding toner image T5-1 formed on the sheet S5. Similarly, a bonding layer between the sheets S5 and S6 is formed only by a bonding toner image T6-1 formed on the sheet S6. A bonding layer between the sheets S6 and S7 is formed only by a bonding toner image T6-1 formed on the sheet S7.

Therefore, for example, the amount of bonding toner per unit area in the bonding layer between the sheets S4 and S5 is determined only by the application amount of bonding toner applied onto the sheet S5 by the image forming section 101B.

In the present embodiment, the density of the bonding toner image 39 formed on each sheet by the image forming section 101B (application unit) may be constant.

According to the present embodiment, for example, the amount of bonding toner per unit area in the bonding layer interposed between the sheet S1 located at the outermost position and the sheet S2 adjacent to the sheet S1 is larger than the amount of bonding toner per unit area in the bonding layer close to the central portion of the booklet Bk. In other words, a layer of adhesive formed between the first sheet located at the outermost position of the booklet in the thickness direction of the booklet and the second sheet stacked on the first sheet is defined as a first bonding layer, and a layer of adhesive closer to the center of the booklet in the thickness direction than the first bonding layer is defined as a second bonding layer. At this time, the amount of adhesive per unit area in the first bonding layer is larger than the amount of adhesive per unit area in the second bonding layer.

As a result, it is possible to satisfy the necessary booklet strength, while avoiding an excessive amount of bonding toner in the central portion of the booklet Bk, and it is possible to reduce the amount of bonding toner consumed for producing one booklet Bk.

In this manner, according to the present embodiment, it is possible to provide a booklet producing apparatus and an image forming apparatus capable of reducing the consumption amount of adhesive while suppressing the decrease in the peeling strength of the booklet.

Further, according to the present embodiment, since the image forming section 101B (application unit) does not perform processing of changing the application amount of bonding toner applied onto the sheet for each sheet, the processing of the control section 131 regarding the application of the bonding toner can be simplified.

### Third Embodiment

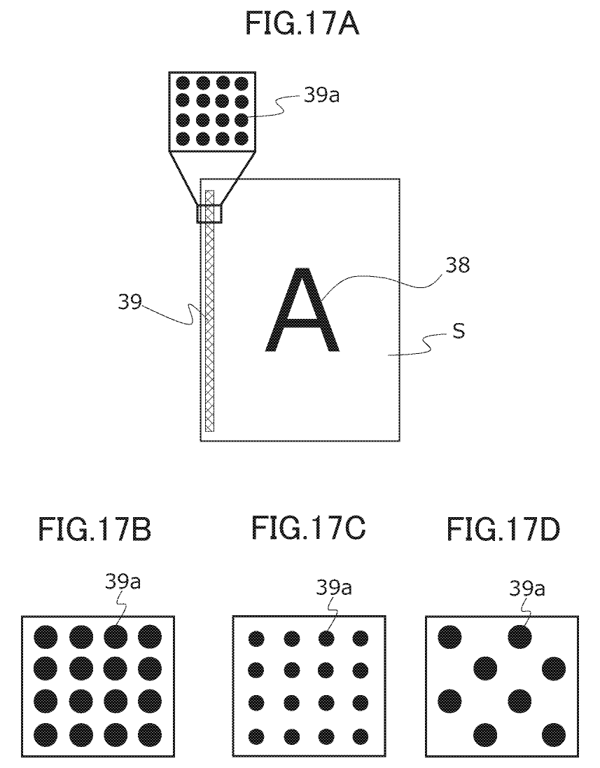

A configuration of an image forming apparatus 100 (booklet producing apparatus) according to the third embodiment will be described with reference to FIGS. 17A-17D. Hereinafter, in the description of the present embodiment, unless otherwise specified, elements denoted by the same reference signs as those in the first embodiment have basically the same configurations and operations as those described in the first embodiment, and differences from the first embodiment will be mainly described.

FIG. 17A illustrates an example of a toner image formed on the sheet S in the present embodiment. FIGS. 17B-17D are schematic views illustrating patterns of bonding toners.

As illustrated in FIG. 17A, the bonding toner image 39 according to the present embodiment is not distributed at a constant density in a predetermined region (bonding region) on the sheet S, and has a pattern in which image elements 39a having such a size as to be visually recognized with the naked eye are arranged. Here, the pattern in which circular dots are arranged in a lattice form as the image elements 39a has been exemplified, but the image elements may be, for example, straight lines or short line segments, and the arrangement method may be, for example, a triangular lattice form.

FIGS. 17B-17D are enlarged views of bonding toner images 39 having different amounts of bonding toner per unit area according to the present embodiment. In the pattern of FIG. 17C, the circular dots have a smaller radius than those in the pattern of FIG. 17B. Therefore, in the pattern of FIG. 17C, the ratio (i.e., image coverage or coverage) of the surface area of the sheet S covered with the bonding toner image to the bonding region of the sheet S is smaller than that in the pattern of FIG. 17B. In the pattern of FIG. 17D, the number of circular dots is smaller than that in the pattern of FIG. 17B. Therefore, in the pattern of FIG. 17D as well, the ratio (image coverage or coverage) of the surface area of the sheet S covered with the bonding toner image to a predetermined region (bonding region) on the sheet S is smaller than that in the pattern of FIG. 17B.

That is, the amounts of bonding toner per unit area of the bonding toner images 39 formed using the patterns of FIGS. 17C and 17D are smaller than that of the bonding toner image formed using the pattern of FIG. 17B. Conversely, by increasing the radius of the circle or increasing the number of dots, the amount of bonding toner per unit area can be increased as compared with that in the pattern of FIG. 17B.

In other words, the control section 131 according to the present embodiment causes the image forming section 101B (application unit) to apply the adhesive to the bonding region (predetermined region) of the sheet according to a pattern including a region to which the adhesive is applied and a region to which the adhesive is not applied. In addition, the control section 131 according to the present embodiment changes the amount of adhesive per unit area of the layer of adhesive formed between each pair of adjacent sheets in the produced booklet by changing the coverage, which is a ratio of the area of the region to which the adhesive is applied to the area of the bonding region.

As a result, it is possible to reduce the amount of bonding toner consumed for producing one booklet Bk while satisfying the necessary booklet strength. In addition, by reducing the consumption amount of bonding toner, the running cost can be reduced.

In this manner, according to the present embodiment, it is possible to provide a booklet producing apparatus and an image forming apparatus capable of reducing the consumption amount of adhesive while suppressing the decrease in the peeling strength of the booklet.

The pattern of the bonding toner image is selected such that the booklet strength in each bonding layer of the booklet Bk is equal to or greater than the predetermined necessary booklet strength.

### Fourth Embodiment

In the first to third embodiments, the monochrome printer has been described as an example, but in the present embodiment, a color printer that forms an image using toners of four colors: yellow (Y), magenta (M), cyan (C), and black (K) will be described as an example. Hereinafter, in the description of the present embodiment, unless otherwise specified, elements denoted by the same reference signs as those in the first embodiment have basically the same configurations and operations as those described in the first embodiment, and differences from the first embodiment will be mainly described.

The image forming apparatus 100 according to the present embodiment includes three more process cartridges having the same configuration as the process cartridge 195 described in the first embodiment. That is, the image forming apparatus 100 according to the present embodiment includes four process cartridges 195. Each of the four process cartridges 195 forms single-color toner images using toners of four colors: Y, M, C, and K therein. When the production of the booklet is supported, it is assumed that the bonding toner image 39 is formed in at least one of the four process cartridges 195.

The four process cartridges are arranged side by side along the intermediate transfer belt 108 (FIG. 1). The single-color toner images formed in the respective process cartridges 195 are primarily transferred from the photosensitive drum 102 to the intermediate transfer belt 108 so as to be superimposed on each other on the intermediate transfer belt 108. As a result, a recording toner image 38, which is a full-color toner image, and a bonding toner image 39 are formed on the intermediate transfer belt 108.

In the secondary transfer portion, the recording toner image and the bonding toner image are transferred to the sheet S. The recording toner image and the bonding toner image transferred to the sheet S are subjected to fixing processing by the fixing device 118. Further, the sheets S are stacked within the post-processing apparatus 106, and the heat-pressure bonding section 167 performs a heat-pressure bonding operation (bonding operation), whereby the sheets S are bonded to each other via the bonding toner image 39.

In the present embodiment, for example, by changing the number of colors of toners used to create a bonding toner image 39, the amount of bonding toner per unit area in the bonding layer of the produced booklet can be controlled. For example, the plurality of process cartridges 195 form bonding toner images 39 on a sheet serving as a front cover or a back cover and a sheet facing it such that the bonding toner images 39 formed using toners of a plurality of colors are superimposed on each other on the sheet S. On the other hand, only one process cartridge 195 forms bonding toner images 39 such that the bonding toner images 39 are formed using only a single-color toner on sheets facing each other at the central portion of the booklet.

In other words, the image forming section 101B (application unit) according to the present embodiment includes a plurality of process units (a plurality of process cartridges 195) using different types of toners as adhesives. The control section 131 according to the present embodiment changes the amount of adhesive per unit area in the bonding layer of the produced booklet by changing the number of process units used for creating a toner image for bonding sheets to each other among a plurality of process units.

In the present embodiment as well, the amount of bonding toner per unit area in the bonding layer at the central portion of the booklet is smaller than the amount of bonding toner per unit area in the bonding layer close to the outermost position of the booklet. In other words, a layer of adhesive formed between the first sheet located at the outermost position of the booklet in the thickness direction of the booklet and the second sheet adjacent to the first sheet is defined as a first bonding layer, and a layer of adhesive closer to the center of the booklet in the thickness direction than the first bonding layer is defined as a second bonding layer. At this time, the amount of adhesive per unit area in the first bonding layer is larger than the amount of adhesive per unit area in the second bonding layer.

As a result, it is possible to reduce the amount of bonding toner consumed for producing one booklet Bk while satisfying the necessary booklet strength. In addition, by reducing the consumption amount of bonding toner, the running cost can be reduced.

In this manner, according to the present embodiment, it is possible to provide a booklet producing apparatus and an image forming apparatus capable of reducing the consumption amount of adhesive while suppressing the decrease in the peeling strength of the booklet.

### Modification

In a case where there is a difference in bonding strength or cost among the four color toners, it may be preferable to preferentially use a toner with high bonding strength or a toner with low cost as a bonding toner. That is, it may be preferable to form a bonding toner image 39 using only one color toner with the highest bonding strength or with the lowest cost at the central portion of the booklet. Accordingly, the cost for producing the booklet can be further reduced.

The toner serving as adhesive may be a bonding-dedicated toner (transparent toner) different from the toners of four colors: Y, M, C, and K. In this case, any one of the four process cartridges 195 may be replaced with a process cartridge 195 using a bonding-dedicated toner. In addition to the four process cartridges 195 corresponding to the four colors: Y, M, C, and K, the image forming apparatus 100 may include a fifth process cartridge 195 using a bonding-dedicated toner.

The configuration of the color printer according to the present embodiment may be applied in combination with the controls according to the first to third embodiments. For example, a black toner may be used as a bonding toner, and a density of a bonding toner image 39 formed using the black toner may be changed (the first embodiment), switching may be performed between single-sided printing and double-sided printing (the second embodiment), or a pattern constituting the bonding toner image 39 may be changed (the third embodiment).

### Other Modified Embodiments

A plurality of methods of changing the amount of adhesive per unit area in the bonding layer of the booklet described in the above-described embodiments may be combined. For example, the toner amount per unit area in each bonding toner image may be changed by the method according to the first, third, or fourth embodiment, in addition to the control of switching between single-sided printing and double-sided printing for a sheet surface on which a bonding toner image is formed, which has been described in the second embodiment. As a result, it is possible to further expand the range in which the amount of bonding toner per unit area can be adjusted.

In each of the above-described embodiments, an example has been described in which the closer to the outermost position of the booklet the bonding layer is, the greater the amount of bonding toner is, and the closer to the central portion of the booklet the bonding layer is, the smaller the amount of bonding toner is. The amount of adhesive per unit area in the bonding layer is not limited thereto, and may be changed depending on conditions other than the position of the bonding layer in the thickness direction of the booklet. For example, in a case where a material of a sheet serving as a front cover or a back cover is different from the materials of the other sheets, sufficient booklet strength may be realized even with a smaller amount of adhesive. In this case, the amount of adhesive in a bonding layer formed between the sheet serving as the front cover or the back cover and the sheet adjacent thereto may be smaller than that in the bonding layer at the central portion of the booklet.

In addition, even at the same position of the bonding layer in the thickness direction of the booklet, the amount of adhesive may vary depending on conditions such as the type and size of sheets to be used for producing a booklet and the number of sheets constituting one booklet.

The "adhesive" used for producing a booklet is not limited to the toner, and may be a liquid adhesive (glue). In this case, instead of the image forming section 101B described in the above-described embodiment, an inkjet-type printing unit using a liquid adhesive as an ink can be used as the application unit.

In each of the above-described embodiments, as an example of a bonding unit, the heat-pressure bonding section 167 including the heater section 171 including the ceramic heater 168 and configured to heat and pressurize a bonding toner serving as adhesive using the heater section 171 has been exemplified. The bonding unit is not limited thereto, and for example, a heating section (e.g., an oscillator that generates ultrasonic vibration for heating a bonding toner using ultrasonic vibration) other than the ceramic heater 168 may be used. Instead of the configuration in which the sheet bundle is pressurized using the pressurizing plate 169 (pressurizing member) moving in the thickness direction of the sheet bundle, for example, a bonding unit that conveys the sheet bundle while being pressurized by being nipped at a nip portion between a pair of rollers may be used. In this case, a heating section (e.g., a halogen lamp disposed in an internal space of the roller) for heating the bonding toner is disposed on at least one of the two rollers constituting the roller pair.

In each of above-described embodiments, the image forming apparatus 100 has been described as including the printer body 101 having an image forming function (printing function), but the "booklet producing apparatus" may not have the image forming function (printing function). For example, in the above-described embodiment, a transparent toner serving as adhesive may be contained in the process cartridge 195, and the image forming section 101B serving as an application unit may form only a bonding toner image on a sheet without forming a recording toner image.

As described above, in the booklet producing apparatus, it may be preferable to apply a sufficient amount of adhesive onto a sheet so as to obtain a desired peeling strength. On the other hand, it may be preferable to reduce the consumption amount of adhesive in the booklet producing apparatus.

According to the present disclosure, it is possible to provide a booklet producing apparatus capable of reducing consumption of adhesive while suppressing a decrease in peeling strength of a booklet.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-041696, filed Mar. 14, 2025, which is hereby incorporated by reference herein in its entirety.

What is claimed is:

1. A booklet producing apparatus comprising:
an application unit configured to apply adhesive onto a sheet;
a stacking portion on which a plurality of sheets onto which the adhesive has been applied by the application unit are stacked;
a bonding unit configured to nip and bond the plurality of sheets stacked on the stacking portion with the adhesive; and
a control unit configured to execute an operation of producing a booklet in which each pair of adjacent sheets are bonded to each other via the adhesive using the application unit and the bonding unit, the control unit being configured to control the application unit such that an amount of the adhesive per unit area of a layer of the adhesive formed between each pair of adjacent sheets in the booklet varies depending on a position of the layer of the adhesive in a thickness direction of the booklet.

2. The booklet producing apparatus according to claim 1, wherein
in a case where a layer of the adhesive formed between a first sheet located at an outermost position of the booklet in the thickness direction and a second sheet adjacent to the first sheet is referred to as a first bonding layer, and a layer of the adhesive that is closer to a center of the booklet in the thickness direction than the first bonding layer is to the center is referred to as a second bonding layer, the control unit is configured to control the application unit such that the amount of the adhesive per the unit area in the first bonding layer is larger than the amount of the adhesive per the unit area in the second bonding layer.

3. The booklet producing apparatus according to claim 2, wherein
the control unit is configured to control the application unit such that the closer to the center of the booklet in the thickness direction the layer of the adhesive is, the smaller the amount of the adhesive per the unit area is.

4. The booklet producing apparatus according to claim 1, wherein
the control unit is configured to cause the application unit to uniformly apply the adhesive over a predetermined region of the sheet, and change the amount of the adhesive per the unit area within the predetermined region.

5. The booklet producing apparatus according to claim 1, wherein
the control unit is configured to change the amount of the adhesive per the unit area of the layer of the adhesive by selectively performing (i) applying the adhesive to both of two facing surfaces of the adjacent sheets or (ii) applying the adhesive to only one of the two facing surfaces.

6. The booklet producing apparatus according to claim 1, wherein
the control unit is configured to cause the application unit to apply the adhesive to a predetermined region of the sheet according to a pattern including a region to which the adhesive is applied and a region to which the adhesive is not applied, and change the amount of the adhesive per the unit area of the layer of the adhesive by changing a coverage that is a ratio of an area of the region to which the adhesive is applied to an area of the predetermined region.

7. The booklet producing apparatus according to claim 1, wherein
the application unit includes a plurality of process units that use different types of toners as the adhesive, and
the control unit is configured to change the amount of the adhesive per the unit area of the layer of the adhesive by changing the number of process units used for creating a toner image for bonding sheets to each other among the plurality of process units.

8. The booklet producing apparatus according to claim 1, wherein
the adhesive is a toner,
the application unit is configured to form a toner image using the toner in a predetermined region where the pair of adjacent sheets are bonded to each other, on at least one of two facing surfaces of the pair of adjacent sheets in the booklet, and
the amount of the adhesive per the unit area is a value obtained by dividing a total mass of the toner applied on the two surfaces within the predetermined region by an area of the predetermined region.

9. The booklet producing apparatus according to claim 1, wherein
the adhesive is a color toner, and
the application unit is configured to form a first toner image for recording an image and a second toner image for bonding sheets to each other on the sheet by using the color toner.

10. The booklet producing apparatus according to claim 1, wherein
the bonding unit includes a pressurizing member movable in the thickness direction with respect to the plurality of sheets stacked on the stacking portion, and a heating unit configured to heat the adhesive via the pressurizing member.

11. The booklet producing apparatus according to claim 10, wherein
the heating unit is a heater configured to generate heat when supplied with electric current.

12. The booklet producing apparatus according to claim 10, wherein
the heating unit is an oscillator configured to generate ultrasonic vibration.
